(19) United States
(12) Patent Application Publication
(10) Pub. No.: US 2016/0125857 A1
(43) Pub. Date: May 5, 2016

(54) Tablature-Proofing Turing Machine

(71) Applicants: Terence B. Allen, Spokane, WA (US); James L. Bury, Spokane, WA (US); Brock S. Allen, San Diego, CA (US)

(72) Inventors: Terence B. Allen, Spokane, WA (US); James L. Bury, Spokane, WA (US); Brock S. Allen, San Diego, CA (US)

(21) Appl. No.: 14/992,801

(22) Filed: Jan. 11, 2016

Related U.S. Application Data
(60) Provisional application No. 62/101,577, filed on Jan. 9, 2015.

(51) Int. Cl. G10G 1/04; G06N 7/00; G06N 99/00

(52) U.S. Cl. CPC G10G 1/04; G06N 99/005; G06N 7/005; G10H 2220/015; G10H 2250/131

(57) ABSTRACT

Guitar music is metricized by the Baire Category Theorem, an L-space existence proof for the Tablature-proofing Turing Machine T(G). T(G) quantifies the guitar model in sentences constructed using first-order predicate logic. Music spectrology and graphology use a guitar language signature as a geometric engine of projection that predicts how subsets of the musical key topology in Rⁿ are embedded in R² coordinate plane by projection. K spectrums are T(G) collections of inductive non-trivial L-facts proving tablature is computable to use K-facts to pullback guitar intelligence.

### RELATED APPLICATIONS

This utility patent application claims the benefit of earlier filed U.S. Provisional Patent Application No. 61/750,637 filed on Jan. 9, 2013 titled Arithmetic Procedure Using Pitch-Position Algorithm to Transform Tablature Music to Any Musical State of System, and also claims priority to earlier filed U.S. Provisional Patent App. No. 61/925,438 filed on Jan. 9, 2014 titled Arithmetic Procedure Using Semi-Algebraic Pitch-Position Algorithms to Transform Written Music into Any Fundamental State of System Using Harmonic Functions in a Hilbert Overtone Space of Prime Harmonic Values, and also claims priority to earlier filed U.S. Provisional Patent App. No. 62/101,577 filed on Jan. 9, 2015 titled Autodidactic Anti-Gibberish Device for Guitar: A Guitar Music Self-Learning Machine.

The entire contents of said earlier filed US Provisional patent applications are all expressly incorporated herein by this reference.

This application incorporates mathematics already in the public domain found in mathematic literature including, but not limited to: 1) Pin-hole camera theory as disclosed in GEOMETRY OF MULTIPLE IMAGES (O. Faugeras and Q-T Luong, 2001, MIT Press), which explains the geometry of the invention and documents the potential for economic, educational, and cultural value of perspective projections for light, and by implication for spectral images in music; 2) Theory of the Turing Machine can be found in MODEL THEORY: AN INTRODUCTION, D. Marker, Springer-Verlag, New York, 2010; 3) Graph Theory (pitch-position graph is not planar) as disclosed in GRAPH THEORY, R. Diestel, Springer-Verlag, New York 2010; 4) Boolean algebra and the important work of Marshall Stone as disclosed in STONE SPACES, PT Johnstone, Cambridge Univ. Press, Cambridge, 1986. The mathematics described in these books is used to disclose the invention herein.

### PREFACE TO FIELD OF INVENTION

A Turing machine captures the concept of a proof: The machine halts if language L is proof of T(G) and does not halt if language L is not proof of T(G).

An existence proof for a Turing machine is required because no one has yet observed that tablature is a mathematic construction of algebraic sentences that can be proofed, and there is no general recognition that guitar intelligence is more valuable than music intelligence.

Our theory that a proof tablature is computable leads to the invention of music spectroscopy and music graphology, which are two new tools for learning music intelligence and which are off-shoots of the existence proof of concept.

### FIELD OF INVENTION

Both music spectroscopy and music graphology deal with concern how guitar music is best depicted in print and educational material.

Field is a word with several and substantial meanings such that defining the field in which our invention operates is tantamount to defining the invention itself.

The primary field in which the invention lies is the field of guitar music intelligence which is defined as the collection of facts that are the necessary and sufficient knowledge and information required to learn how to read, write, and play guitar music, and achieve guitar music literacy and make guitar music literature and guitar music libraries.

Field herein also means: 1) a place where music is drawn or projected, and hence to music scores and other intelligence collected as seminal works in archives, songbooks, and libraries that make a body of music literature; 2) a music space containing points, lines, sets, arrows, ordinal cardinals; 3) the area visible through a lens of an optical device that projects a music field on to a plane of music observation; 4) an area put to a particular music purpose such as the guitar fret board matrix of string and fret position values in the guitar model; 5) an area of activity or a prime source of music intelligence information, particularly guitar music literacy; 6) an expanse of the musical key expression under homeomorphic agents such as tuning and intonation; 6) an algebraic field of intonation and tuning values, with and without the guitar model quantitation, 7) a field of intonation state of system polynomials that define a polyphonic musical system, and 8) a mathematic structure or topology of music fields.

When two music fields are connected by arrows, the collection of connecting arrows make a new field of music values called the adjoint field.

The guitar fret board matrix defines the guitar model. Tablature notation defines the tablature closed algebraic field. “The guitar model plus the tablature algebraic field is the guitar algebraic geometry that is used to construct and proof guitar music intelligence.

Tablature is a formal language of guitar that is first-order logic plus an octave identity matrix. The symbols and the rules in tablature are precise such that the rules can be used to build up sentences from the fret number symbols which say something about guitar music. Meaning and order in the guitar language are accomplished by a basic truth structure which marries each ordered pair (sentence, tuning) to a true or false value. The truth structure {0, 1} on the guitar tuning is a bridge that connects the formal language of the tablature notation system to the interpretation of the tablature by means of the guitar model. The guitar language, the guitar model, and the guitar interpretation are the vertices of an ABC triangle.

Musical spectrology and music graphology are adjoint fields of music that connect a triangulated path amongst 3 fields: 1) mathematics, 2) music, and 3) guitar music, which form a triangle using the Baire Category Theorem to prove that tablature music for guitar is computable by a machine because there is a metric space defined by the topology.

A machine for constructing and proofing tablature music for guitar using Turing-machine proofed facts is useful economically in various fields including but not limited to: 1) Music Education and Publishing; 2) Guitar Learning and Writing; 3) Artificial Intelligence Machines for Learning Guitar; 4) Applied Mathematics of Music Topology.

A machine that constructs and proofs L-sentences in tablature serves these fields by using K-facts collected from K spectrums for constructing a library of L-sentences in a log space family of L-languages. Guitar music scores in the library may be proofed in L-tablature notation using K spectrum intelligence, a procedure that can benchmark a new mathematically-literate idiom of tablature.

The general scheme for music intelligence is shown by the diagram in FIG. 1 BASIC MUSIC INTELLIGENCE APPARATUS.

Anything computable may be computed using a Turing machine. If tablature notation can be computed, then there must be a Turing machine that proofs tablature. The Turing machine that constructs and proofs tablature is the equivalent of a pushdown automaton that is more correct and precise by relaxing the requirement that every pitch have only one position.

Tablature is useful intelligence that is sufficient by itself for learning guitar. Tablature may be read without learning to read scored music first, suggesting that tablature may also be written knowing only the guitar tuning and nothing else. It appears the guitar is a Turing machine that manipulates the tablature input data strip and halts, accepting that the tablature is proof of the Guitar Tuning Theory.

Both Spectrology and Graphology concern how music is depicted in print. Music in print can be depicted as a score or scordatura, written as images on a staff of horizontal lines; or music can be depicted as a succession of image frames, using algebraic and geometric fields of numbers, points, arrows, and lines that are assembled as algebras of tablature and also as matrices, symbolic codes, graphs, frequency distributions, geometric diagrams, and other images written or drawn on a data strip or tape to be manipulated by a Turing machine.

A spectrum is a 3-dimensional object connected by arrows to images of the object in 2-dimensions.

The spectral nature of the instant tablature computing invention is demonstrated by the Pierce (P), Zariski (Z), and Keimel (K) spectrums on Guitar.

Music is understood completely by ear using pitch which reduces music to points and intervals that fall on a line and appear to be inside the frequency domain. In fact, the system fundamental is a point of origin for a musical structure that is connected to frequency by a key function that makes a unit and a direction perpendicular to the real number line. When the octave interval is added, a third unit and direction is defined. This construction establishes music is in a topologic L-space and connected to the real numbers at a point at which the fundamental is witnessed by intonation at specific pitch.

The musical spectrum topology is based on the topologic relation between the maximal and minimal expression of the musical scale product set. The maximal expression of music intelligence is far too complex to learn or to be useful in a practical way. The minimal expression of music intelligence is a useful aid for learning music, but this expression trivializes the expression of music, in the sense that this expression assumes there is one and only one universal musical key, and the universal set-of-all sets musical key always sounds the same for every polyphonic instrument and notational system.

The musical key therefore creates an illusion which deceives us into believing that changing the key and the tuning is trivial when in fact it is not at all trivial because the tuning and the keys within the tuning are music that is extremely disconnected from the musical key itself. Extremely disconnected means the when the bond between the music and guitar is “cut,” the bond cannot easily be recovered.

The spectral images of the guitar are the arrows that connect music and guitar music. When a spectrum is defined in the frequency spectrum of sound, the spectrum is a frequency spectrum. When a spectrum shows how often elements in a set are used it is a probability of usage spectrum. When a spectrum shows an order that is not strictly increasing, decreasing, or constant, that spectrum is called a K spectrum 50.

The three distinct spectral images of the guitar tuning matrix arrows are shown in FIG. 2 PIERCE (P)30, ZARISKI (Z)40, AND KEIMEL (K)50 SPECTRUMS (P, Z, AND K Spectrums, (30, 40, 50 respectively)) for a guitar tuning in popular usage. The three distinct spectrums (P, Z and K) are vectors, matrices with one row of coordinates, that are arrows (morphisms) reduced to a canonic point with six coordinates called a six-tuple. P 30 and Z 40 are equivalent and determine K 50 as a proven fact in the L-language of the Guitar Zariski 40 topology.

The guitar spectrum of music expression topologically lies somewhere in between the minimal and maximal expressions of music. The guitar requires higher-order music intelligence (group) than the musical key (set). Higher-order guitar intelligence means higher-dimensional structure in the guitar group than the musical key set, and higher-dimensional thinking in the guitar group has no natural representation or simple arithmetic that can be used to deduce guitar intelligence facts.

Thinking in higher dimension is too complex for anyone to grasp mentally without substantial higher level training in mathematics and music. Therefore, a method for understanding guitar using ordinary diagrams and equations to make facts about the guitar model is useful for learning guitar quickly.

Just as the minimal expression of the musical key is a useful learning aid in music, guitar intelligence that is minimal on the guitar model is best for learning guitar. Minimal means the music user does not have to make any calculations in order to read the music score as written for the guitar.

A musical key staff score can be played on guitar but requires annotation of guitar model index numbers, but without a system of rules for calculating which fret on which string is the correct guitar note to play.

The musical key is minimal on the traditional diatonic musical key score staff written using the key signature, and nothing else. The guitar tuning is minimal on the tablature staff written using the tuning, and nothing else.

The guitar and music intelligence are, in topologic parlance, extremely disconnected.

Extremely disconnected in music intelligence does not mean guitar and music are in fact disconnected, because that means music theory is not complete, a reductio absurdum. Instead extremely disconnected intelligence means the facts in music are difficult to translate to guitar because the path that connects L-languages is not intuitive and the path is not easy to construct and proof without the guitar geometric projection matrix formula instructions.

Musical vectors are drawn to quantitate direction, magnitude and distance. Using the key signature staff, the pitch axis is orthogonal to the staff. Pitch is vertical and the horizontal staff is a time frame axis. On the other hand, using tablature the pitch is both orthogonal and parallel to the staff (with one dimension for each string) as well as a time frame. The problem is that the music key score and the guitar music scordatura are extremely disconnected. The K spectrum 50 is the non-trivial collection of facts that can be used to move between the score and the scordatura. This solves an old problem in music: how to understand facts true in scordatura using facts in true scores.

The K spectrum 50 is defined as any non-trivial order observed in any harmonic set. Trivial order is strictly increasing, strictly decreasing, or constant. Any other kind of order is a non-chromatic K spectrum 50 and can be determined directly by counting how often the elements in the set are observed in a field of values. The K spectrum 50 vector coordinates are probability distributions in music theory that result from collections of facts that are already known to be proven true in a musical L-language.

The L-language is proof of the K spectrum 50 fact and the K spectrum 50 fact that is proof of the L-language.

Since guitar music intelligence is actually defined in six dimensional log space, one log space dimension for each guitar string, one must understand facts in L-languages using elements, relations, and functions expressed in two dimensional diagrams that aid in writing L-facts, L-equations, and L-sentences. The method of writing guitar music can be proofed as L-correct usage according to the guitar tuning theory G that initializes the proofing machine, which is the Z/P spectrum 40, 30 respectively.

The Zariski Guitar Topology Z 40 determines K 50 and K 50 is used to learn Z 40.

An algebra of commuting projections of Hilbert Spaces that make guitar tuning spaces can be given the structure of Boolean algebra (Boolean ring), but has no natural representation as algebras of subsets in a Euclidean diagram without the method of quantifier elimination.

The state-of-art in guitar learning and writing is that higher-order guitar intelligence at the present time has no known natural geometry or equational representation. Tablature sentences, it seems, are a secret code that have not yet been cracked.

It is easy to understand music in two dimensions but there is currently no way to think about guitar in six dimensions by a general method without prior special learning. It is important to have a way to reduce the maximal expression of music to the minimal, and then understand how to use the minimal expression to go back to the maximal. There is no other way to learn guitar.

There is no way to represent music in higher dimensions in a natural way that makes sense, therefore a the method for making geometric images in the R² coordinate plane of higher-dimensional mathematic structures in music using a perspective project gathers intelligence in a same mathematical way the spectrum of light emitted by hydrogen reflects transitions in the state of system of the atomic element.

FIGS. 3A-3M MUSIC GRAPH THEORY show a series of graphs in music that reveal an atomic elemental diagram in music, which is a monadic ABC triangle with the equational representation a+b+c=0 (cipher product), a=b+c (decomposition product), and a+b=c (composition product).

The existence proof for a Tablature-proofing Turing machine T(G), which proves Tabs are computable, is another way of saying that there exists an apparatus (called the nullstellensatz in algebraic geometry) that includes all the elements, relations, and functions needed to construct and proof L-sentences tablature. Such an apparatus is said to be “complete” or “recursively enumerable.”

In fact, in the L-language of model theory, the algebraic sentences written in tablature notation are by themselves proof complete (even if the proofs are written with recognizable errors) that there is an intelligent machine. The numbers in tablature have a number theory that is complete since the fret numbers are natural numbers and there is no complete theory of natural numbers.

Proof that Tabs are computable requires a proof of concept.

Model theory means the study of mathematic structures using maps (projections, arrows, sheafs or functors) applied to clopen sets, logical formulas and probability functions in square matrices.

Mathematic structures like guitar can be classified by logical sentences which are true or false.

True or false L-sentences under a commutative lattice make a sophisticated second order logic so that Tabs may be proofed the same way an editor proofs a manuscript using grammar, except using a calculus to discover the editorial rule book.

The term left adjoint refers to a formula for matrix products, intersections, and unions that define the editorial L-rule book.

The term guitar model comes from the mathematical language “Structure G is a model of the sentence L, meaning that L is true in G.”

Any music structure can translate to a set of atomic sentences, and in turn any set of atomic sentences can be turned into a music structure.

The machine that constructs and proofs L-sentences has a concise elemental definition while the collection of L-sentence in the atomic diagram is too large to capture.

Once the guitar music model G is classified as a computable L-structure, then guitar model theory shifts to the question of how Tablature L-sentences are constructed and proofed as correct. The guitar theory is just the sum total collection of L-facts. The analogy for the Tablature-proofing machine is a person who goes from cell-to-cell in the Tablature, reading, writing and erasing items within the Tablature memory cells according to “L proof of G” grammar and syntax instructions that are facts (statements proven true) internal to the guitar model using predicate logic.

The person operating the machine is not necessarily literate in guitar but becomes literate by erasing and writing better proofs. The initial Tablature input construction need only be a guess at a correct L-sentence.

Tablature Syntax refers to the purely formal structure of Tabs, for example, the length and symbols used in a sentence. Tablature semantics refers to the interpretation and meaning of a Tablature sentence construction—whether or not the L-sentence is true or false. There is no equation for the truth structure in Tablature. The truth structure of the Tablature can only be acquired inductively by a set of proofs.

Without reference to the guitar, the L-sentences make no sense without the Tablature truth structure, no more than facts in a foreign language make sense without special learning. This means the L-reading, L-writing, and L-erasing procedures used to process Tablature data make no sense, indeed are not even defined, without knowing the Guitar Zariski Topology.

The mine of new economic value that Zariski spectrology and L-structure multigraphs open up is comparable to the recent advances in the economic development of pin-hole camera theory in computer images.

The “holy grail” is the left adjoint free functor of G (an arrow defined inside G). The left adjoint matrix product formula for a sum is a novel approach to learning guitar which solves the difficult problem of guitar intelligence pullback.

Music publishers face a continual and difficult problem deciding how to depict guitar music in print. The problem of knowing how to depict guitar intelligence properly is solved using the left adjoint matrix product formula to determine how to best construct Tabs when the guitar music composer does not read or write music and fails to make an authentic holographic score.

Because pitch value and musical key parameters are the same for every instrument, for every tuning, and every tuning-key combination, it seems as if the guitar tuning intelligence is “forgotten” and according to affine theory the tuning and key, once “lost”, are impossible to recover. The K spectrum 50 proves this is not true because facts about the tuning are learned from the K spectrum 50, which proves there is indeed a left adjoint free functor for recovering guitar intelligence after intonation.

If the guitar tuning was lost on intonation, then every guitar tuning would be equally likely so the observation that about a dozen guitar tunings are more probable and all the rest are highly improbable is a fact that is an affine theory anomaly.

The left adjoint free functor is the morphism (arrow) that “remembers” the maximal guitar intelligence from the minimal musical key and pitch value intelligence. See FIG. 3H (Forgetful Diagram); and FIG. 3I (Commutative Square).

“Left adjoint” means a square matrix having the property that its product (equivalently herein a sum) is equal to the determinant of the given matrix times the octave identity matrix. The formula for the matrix is called the pitch-position equivalence relation E.

The given matrix is the product set of the musical scale; the identity matrix is the octave identity matrix (product set of [0, 1]); and product matrix of the left adjoint free functor is the open lattice of the musical key. All the matrixes are isomorphic to log space.

The L-language for tablature is defined as L={E}.

The left adjoint free functor is just one of the operators in the Tablature algebraic field closure operator, which is the collection of all elements, relations, and functions that define the algebraic language L internal to guitar tuning theory G, therefore, in mathematic parlance, L is proof of G.

The left adjoint free functor is the diagonal arrow in FIG. 3I Commutative Lattice with Left Adjoint Vector.

The equivalent of the left adjoint vector in algebraic geometry is the multigraph in graph theory which forgets the direction of its edge.

Our Tablature Proofing Turing Machine defines precisely the guitar model theory closure and interior, which metricizes and therefore mathematizes, Tablature notation as completely decidable.

Our Tablature Proofing Turing Machine demonstrates the use of an apparatus well-known in the field of mathematics, sub field algebraic geometry, called the nullstellensatz (literally meaning a field of vanishing polynomials), and uses the concepts of minimal, maximal, and extremely disconnect topologic sets, to show how understanding the matrix formula in the scordatura may be used to construct and proof tablature. See FIG. 11. GUITAR MUSIC INTELLIGENCE APPARATUS.

Our Tablature-proofing computation apparatus demonstrates a proofing apparatus in music, which is manifold (multi-faceted) in to a surprising degree.

The K spectrum 50, for instance, is uniquely important music intelligence but not previously understood in theory or practice.

The spectral method in music is a direct analogy to the spectral theory of light, except the octave metric log space applies uniquely to the radiation of sound because electromagnetic radiation has no octave point and interval.

The spectral nature of the guitar computing machine described herein can be appropriately compared to a discrete, finite type of a hypothetical camera or abstract spectroscope that forms a spectral image of musical objects as a geometric projection engine. The goal and purpose of the camera analogy is using perspective projection for making useful diagrams and equations that are reliable music intelligence for learning to read, write, and play music.

The guitar model is particularly important for understanding how perspective projections geometrically are used to achieve guitar literacy and make guitar literature, by understanding how the musical key set is embedded by a projection in the guitar group structure as an image of the musical key uniquely determined by the tuning and nothing else.

The spectral apparatus described here, which in its most general form is the natural music-proofing machine, is labelled the “Turing Machine for Guitar G”, which can be spoken as “T of G” and written T(G).

The output of T(G) is L-sentences in G and also graphs, or equations for graphs in the R² coordinate plane, that are used to depict musical L-fields of intonation value numbers, points, and lines that are spectral images and spectrograms revealing intelligence about the higher dimensional L-structure of the music product set topology.

A signature of the structure G is the set of guitar constants and for each separate n>0 the set of twelve-tone relation symbols and the set of twelve-tone function symbols of G.

The L-signature of rings in G is (+, *, 0, 1). The L-signature of partial orders is the “less-than” function (≦). The L-signature of the lattice is just intersection and union. The L-signature of the group is multiplication, addition, 0, 1.

An intonation value, which may be a tone point or equivalently a tone interval, is a primary harmonic element that is known as a simple product of the fundamental. Simple product means the product set can be indexed using an L-space using natural numbers. L-sentence construction concerns only simple products triangulated using the fundamental signature.

Secondary harmonic characteristics (volume, duration, timbre, rhythm, etc.) that are not inside the fundamental state of system are excluded from mathematic computations in L-sentences.

Secondary harmonic attributes are defined by attributes that are not simple multiples of the fundamental mode of vibration and these secondary values are assumed or intended to be the same for every L-sentence. A Turing Test, which is a test to see if the Turing machine actually writes guitar music like a human, might include the fidelity of secondary harmonic characteristics in the output as a measure of output sentence validity.

The Z 40 and P 30 spectrums are Zariski Topology spectrums that initializes the tablature proofing machine by specifying the specific L-language used to construct the algebraic field of Tablature over the elements and range of the guitar.

There are many L-languages but only a few appear in the L-language K spectrum 50 of guitar and those are the only tunings worth learning because they are the tunings that are already proofed correct by popular usage. All the other tunings do not proof well.

The K spectrum 50 of the Zariski Topology is the non-trivial order that is first constructed and then used by the Turing machine proofing apparatus to determine the best possible Turing machine output. The machine for constructing and proof Tablature begins in an illiterate state by proofing facts which are in turn used to make more proofs, which creates a system of literate facts according to the frequency of usage observed in a field of values using the K spectrum 50 profile. This method fulfills the model theory prediction that an isomorphic copy of the algebraic field can be recovered. The left adjoint matrix formula can be learned by proofing the K spectrum 50 in a field of values.

The K spectrum 50, applied in a different context, for letters in the alphabet, is the basis of a well-known cryptologic technique that matches the probability spectrum of a symbol in a cryptologic field of values keyed to the fingerprint spectrum of a known alphabet. The alphabet has a chromatic ordinal (the alphabetic order) and a harmonic ordinal (the order of most probable usage). The alphabetic order is trivial information, but the order of frequency of letter use in a code is important intelligence for understanding order and meaning.

In the same way as is the case for the alphabet of symbols, the law of averages in music does not make each element, relation, and function in the signature equally probable. The difference between the chromatic order and the harmonic order is music theory. (“Music Model Theory=Chromatic order−Harmonic Order” is the ABC triangle).

To illustrate how an isomorphic copy of the left adjoint matrix formula is recovered analytically using K-facts and L-sentences, consider for example, how an isomorphic copy of a piano score can be recovered from a piano roll (without any intelligence facts regarding the piano roll mastering and playing devices).

If a single perforation on any piano roll is connected to a single piano key note, then the entire piano roll L-language may be decoded by the revelation of the single piano roll fact that perforation A is connected to piano key A by an arrow. The single prime value arrow identifies the entire identity matrix between piano keys and piano roll perforations. Nothing more is required to learn the piano roll L-language than the key witness function establishing the level of intonation for the notation device.

Guitar intelligence, which might be printed on a data strip of tablature, however, would not be understood by a single prime ideal. Cracking the Tablature code requires a key with six partitions. The piano roll is a simple pushdown automaton where pitch and position have a 1-to-1 relation, but the guitar machine is not so simple a device that it can be captured by one key function.

The Z 40, P 30 and K 50 Spectrums, and other music graphs, are depictions used herein to prove the Tablature-proofing Turing machine can construct and proof valid L-sentences in Tablature notation for guitar.

A graphic depiction of music topology concepts is shown in FIG. 5 SPECTRAL THEORY OF MUSIC, which is an artist's schematic concept of mathematics.

The method of computing Tablature sentences uses the simple topologic practice of indexing harmonic set numbers. The guitar model is closed (infinite) but the system of indexing the pitch value, fret, and string sets makes the infinite model finitely two-countable, and therefore commutatively computable.

The two-countability index system for guitar proves there is sophisticated second-order decision logic for guitar formed by the sum of first-order model theory logic plus the commutative transposition lattice, under the octave identity matrix multiplication formula.

The mathematic principle herein is that the basic unit for music topology is the clopen set, which is a set that is both open and closed at once; that is, the clopen set open to union and closed to intersection. A union of clopen sets is complete and defines the interior and the closure of the topology. If the topology is complete, the system is computable.

The fact that the guitar tuning is five-tuple or six-tuple is conclusive evidence the guitar tuple is a Zariski topology.

(Counting the tuning as a five or six-tuple depends on whether the identity of F₀ is counted as 0 or 1. Six is used for simplicity here to match 6 strings.)

Tarski used quantifier elimination to show tuples are decidable and have a natural representation and matrix formula in the real closed field. Our invention applies the quantifier elimination method in music. The guitar model quantification is eliminated on intonation; the pitch model quantifier is eliminated by tuning. The guitar therefore is coded and decoded by the same tuning algorithm used twice, which makes a cipher.

Guitar strings zero-out on the note to which the string is tuned, so the string fundamental key function is in the form of a vanishing polynomial Fᵢ:f(x)=0.

When the tuples are connected by an arrow to a set of vanishing polynomial functions in the form f(x)=0, then there is a field of vanishing polynomials constructed over the interior of the guitar, called a nullstellensatz, that makes a commuting projection of Hilbert spaces of the guitar decision model.

The guitar decision model is versatile because it can be constructed using the signatures of sets, partial orders, morphisms, lattices, partitions, groups, paths, trees, and so on, all based on the equivalence of algebras of prime and principle clopen ideals.

The equivalence of algebras of prime and principle clopen ideals, which depends on a well-known mathematic concept applied in music: The product set of the octave identity is isomorphic to the product set of the twelve-tone sequence in L-space.

The elemental set in the guitar square matrix structure is the n-tuple (or just tuple) and its polynomial signature. The tuple partition is the element common to the music theory existence proof for any system because the tuple makes the algebraic field, nullstellensatz, the model, multigraph, homotopy, and so on.

Every musical object is defined by a tuple and the tuples have a strong K spectrum 50. A tuple is defined as a subset of Rⁿ. The tuple is by definition the union of sets that are clopen, both open and closed. For example, the guitar tuning is a six-tuple such as (0 5 5 5 4 5). The tuple is a precise point and a vector defined in the real number field without pitch quantitation.

The observed ordered pair (musical key, pitch value) is a two-tuple. Chords are mostly three-tuple and four-tuple; scales are usually five-tuple and seven-tuple.

(The Turing machine and its instructions are seven-tuples and five-tuples but the vector coordinates are not defined by partition. That is, the five-tuple and seven-tuple that formalize the turing apparatus are not subsets of the musical key product set.)

The collection of all the possible tuples in music is the family of subsets of the musical key product set topology. The tuples can be thought of as sets defined in the real closed field [0, 1] minus a finite number of points and intervals. The tuples are a semi-algebraic set if they are attached to a set of diaphanous polynomials that make a complete field model.

The guitar tuning (0 5 5 5 4 5) is the most probable tuning, called “Standard,” that is used to illustrate computations consistently throughout this disclosure. Most probable means the most frequent element in the K spectrum 50 of guitar tunings.

When a guitar model is constructed using only elemental sets that are at once both open and closed sets, the fact that the topology is precisely the union of clopen sets means the topologic coverage of the model is complete. Model completeness is tantamount to model computability.

The guitar strings are clopen because the strings are: 1) closed by octave inversion; 2) open to union with the system fundamental.

To elaborate on the concept of clopen guitar string sets, imagine that each string is a ruler placed in a common metric space where rulers can be spaced differently but all rulers rack-up on the same grid, like graph paper. A guitar is tuned on the condition the strings are simple products (sums, herein) of the fundamental. This means the ruler edges can only shift positions according to discrete steps in the grid. The combination of all ruler positions is the guitar tuning language signature. As simple products of the system fundamental, the strings are integral domains inside the fundamental. The system fundamental defines all strings and string relations as arbitrary rings with a common zero and a common set of transitions of state of system in the overtone index system.

The idea that guitar strings are integral domains is important because integral means the guitar strings are a whole topologic unit, with a guitar string signature that is the intersection and union of the string fret position set and the string pitch value set.

The six guitar strings intersect with the system fundamental at six ninety degree angles, illustrating the counter-intuitive nature of guitar tuning space interior. Each distance is located a distance of 1 unit away from every other string in L-space.

The Baire Category Theorem states that if the guitar string is an integral domain, then if follows that the guitar tuning is the union and the intersection of the guitar strings, therefore Tablature is computable.

The Baire proof shows that the guitar model is in fact quantitated over the range and elements of the guitar in first-order model theory by an L-language, a language that can be learned knowing the only tuning primes in the Z 40 or P 30 spectrum that initialize computations. Nothing else is required to proof the facts that make the guitar language theory.

Given the Baire Proof, T(G) is defined. The invention herein embodies the idea that the signature of music language is the union and intersection of integral domains in tuples. The Baire proof defines the interior of the guitar model to be the union of the clopen string sets, and the closure of the model to be the intersection of the clopen string sets. The integral domain of the guitar string is the smallest possible set that covers the guitar model completely. The intersection and union operation, signature of guitar commutative lattice plus the first-order model logic, is the guitar Hilbert space in which L-languages are defined. The lattice of the guitar tuning is defined by the intersection and union of the guitar model index sets.

Zariski topology theory predicts that the lattice of the guitar has a non-trivial equivalence, and that mathematically the non-trivial order has an image projected in the R² coordinate plane. If there is a non-trivial relation in the lattice, the lattice must have a non-trivial K spectrum 50, and that K spectrum 50 probability distribution is determined by the Z/P spectrum 40, 30 (respectively) topology closure.

Restating this model, the coverage of the guitar by six-strings is complete; the interior of the guitar is the union of six strings; and the closure of the guitar is the intersection of six strings. This profound, precise statement of proof may appear disconnected but in fact is a substantial non-trivial connection.

Our invention re-states the proof of invention concept in six equivalent but complimentary ways: 1) Baire Metric Proof, 2) Octave Metric Proof, 3) Model Theory Instruction Proof, 4) Spectrology Proof, 5) Graphology Proof, and 6) Equational Proof.

These proofs demonstrate that the properties of Tablature can only be established inductively using T(G). Any consistent set of sentences can be enlarge to their maximal representation using a step-by-step construction.

T(G) is a model of G, which means that T(G) is a subset set of G. Therefore the set of all T(G) models has the power of 2^{G} in log 2 space.

The Zariski topology in music, and the fact the Z spectrum 40 must have a K spectrum 50 makes the Tablature-proofing Apparatus Existence Proof a powerful geometric, logical, and probability model of the guitar theory G. Furthermore, because whatever is true for guitar music must also hold true for all music (and vice versa), T(G) is also a general model for music key topology (MKT) that preempts other theories of music in the literature.

Music theory can have one of two possible topologic manifolds, a sphere FIG. 4C; or a torus FIG. 4E-3. The spherical and toroidal manifold in music topology are compared in FIG. 4. Only the sphere can be the correct true manifold because only the sphere can reduce to a fundamental. The torus manifold is not correct because it implies music could have two fundamentals, which violates the Law of One Fundamental.

Music in general, must, like the guitar also be the union and the intersection of clopen sets; otherwise music is not a theory. The Z 40, P 30, and K 50 spectral images of music prove music is a theory just like spectral transitions prove quantum theory. Music can no more be a theory quantitated by pitch than light can be a theory quantitated by wave functions in the frequency domain.

The atomic element in music theory, defined as the smallest possible whole unit that cannot be reduced is the integral domain. A guitar string is an example of an integral domain because the string is mathematically a precise unit: 1) there is nothing smaller or greater than the string, 2) nothing can leave the string, 3) the string has an exact top and bottom and a place for every value in between, 4) the unit of the integral domain can join in a union with other integral domains that have in common a single point of origin such that the sum of integral domains is another integral domain. Significantly the integral domain is a collection of discrete values in a continuous union, whose union is also continuous.

The fact that music spectrums and graphs are discrete, simple, and finite does not diminish the continuity value of the spectral intelligence, which reveals computational things that are not directly observable, for instance, the tuning state of system on guitar.

The Baire guitar model predicts that topologically musical objects have three distinct types of spectral images, the P 30, Z 40, and K 50 spectra. These spectra are already well-defined in the mathematic literature and require only a brief explanation to adapt the mathematic spectrums defined in the mathematic literature to music. The P 30 and Z 40 spectrums are precisely the same as the spectrum defined in mathematic literature for Zariski topology and the K spectrum 50 is taken here to be defined by any non-trivial order that is not chromatic set order or index set number order.

The P spectrum 30 is the elemental (the most minimal, non-reducible) signature of the guitar tuning language L in canonic form (tuning intervals or their summation), while the more expansive sum total expression of guitar is called the atomic diagram expression of the tuning. The atomic diagram includes every possible proof. Tablature is a subset of the atomic diagram of the string union and intersection lattice. This satisfies the condition in the formal Turing machine definition that the Tablature is a subset of the tuning and the tuning is a subset of the musical key.

The Z spectrum 40 vector is an equivalent summation of the P spectrum 30 vector. P 30 and Z 40 are vectors and are spectral precisely because they are defined by six points in the frequency domain f. The spectrums P 30 and Z 40 appear to be just vectors, and the vectors are just the same as the spectrums. But the vectors are also facts in the Tablature language of L-sentences in the topologic interior of the guitar and its closed algebraic field.

The K spectrum 50 in mathematics is a non-trivial ordering of elements revealed as an image of the lattice in a graph that proves there is a two-countable non-trivial order in the object lattice. The K spectrum 50 shows that the law of averages does not apply equally to each tonal element, relation, and function, which all have a position (or lack of position) in the their K spectrum 50.

The K-spectrum 50 in music is defined to mean the probability distribution for any set determined by counting the frequency at which a finite number of frequencies are observed in the frequency domain for any field of intonation values.

FIG. 6 MUSIC TOPOLOGY and FIG. 7 INTERSECTIONS AND UNIONS both illustrate topologic concepts graphically as schematic images.

The music spectrogram, music spectroscopy, and music spectrology view the guitar as a geometric engine of projection for making images analogous to the pin-hole camera. The musical graphing of n-tuples in a plane of observation using triviality and triangulation theorems, are off-shoots of the proof tablature is computable.

Because whatever is true for guitar music is also true for all music, and vice versa, if the Baire Proof that tablature is computable correctly captures the spectral images of the guitar as a fact, then the proof also follows from the guitar to show that the music theory signature also has a useful spectral geometry and equational representation in the R² coordinate plane like the guitar signature.

Our invention explains how to make and operate the Turing machine using standard mathematic construction. Describing how to re-phrase L-sentences is highly repetitive and recursive, but each step in re-phrasing is quite simple to do. The executive function which orders the learning tasks (which tunings, keys, and changes to use, for instance, and which path of learning to follow) is more difficult.

Our invention proves that re-phrasing tablature sentences is stepwise and simple using the tuning signature. Rather than describe the step-by-step process for learning guitar, the object here is to show spectroscopy and graphology are powerful tools in an apparatus useful for honing guitar intelligence. The repetitive formulation illustrates the method of saving time and effort by avoiding trial-and-error re-phrasing of music sentences.

The Tablature-proofing Turing Machine has various applications which allow operators to use guitar literature to achieve guitar literacy. The object is to find faster and better paths to mastering guitar intelligence by re-phrasing tabs.

The guitar is probably the most popular musical instrument in the world. Many people would like to learn guitar, but unfortunately guitar is difficult to learn. Guitar music is a subset of music, but learning music never leads to learning guitar, so it seems that music intelligence does not include guitar music intelligence.

“Music is mathematical,” but in fact there is no axiomatic definition of music theory. Much is written about music and mathematics, but very little of that which is written is simple to understand without learning music and mathematics first.

There are three mathematic possibilities for the guitar: 1) Guitar is not connected to music and not predictable using common music constituents, such that constructing and proofing guitar music accurately is extremely difficult and it is nearly impossible to learn to phrase guitar sentences because the guitar signature is too complex; 2) Guitar music is trivial, because any trained guitarist knows how to re-phrase music to guitar, and since all guitars use the same notes, it does not matter how the notes are phrased because the result is the same—all that is required to learn guitar is a pushdown automaton (a purely algebraic calculator); 3) Guitar music has a mathematic system of simple rules homeomorphic to music rules, such that guitar music and music are similar and equal but not the same mathematically, so that one can understand how guitar and music are abstract duals in a way that makes sense (even if the simple guitar rules are in sum total still intellectually difficult to master as a literate form of writing). Both possibilities 1 and 2 above, when taken as assumptions, quickly lead to contradictions which proves them to be false. Therefore, only possibility 3 remains and shows the guitar is an idiomatic idiom where guitar intelligence is peculiar to the guitar L-language.

Tablature is an internal L-algebra for guitar. Because Tablature is a strip of data in the form of natural numbers, the lines and the numbers in tablature compose and algebraic field.

The Tablature field is closed to tonal movement, in the same way the string is closed as an integral domain. When a note moves out-of-bounds (to a range higher or lower than the range of guitar, then octave inversion can always return the note to an equivalent octave tone class that is one octave higher or one octave lower which falls inside the integral domain. Tablature is a closed algebraic field that is constructed above the guitar fret board. An operation in Tablature can result in an impossible phrase but it cannot result in an undefined value and it cannot be true that every element in a set is not indexed by recursive enumeration of each element in a two-count system. This means every sentence in Tabs can be proofed in many ways and is therefore highly determined as correct.

It cannot be true that a mathematic theory of Tablature number computation does not exist and it also cannot be true that there are no instructions for how to construct and proof the Tablature numbers correctly.

The intelligence problem for guitar is that Tablature is too abstract to understand without special learning, but no one has discovered the method for special guitar intelligence that is different from the method for learning music intelligence.

Tablature is a data strip written in an algebraic script depicting a succession of fret position index number vectors written on a horizontal staff of six string lines.

Tablature numbers are “paint-by-numbers” that anyone can read but the numeric script is undefined without knowing the guitar tuning signature used to read and write the Tabs.

It is impossible to learn the pitch value or musical key by looking at the Tablature without making computations, which has always made Tablature a poor intellectual relation of the musical score, but the “paint-by-numbers” utility of Tabs also means that Tablature can be used to learn guitar without learning to read music or knowing anything else except how the guitar is tuned. The Tabs are disconnected from the music but sufficient to learn guitar.

Since Tablature can be read directly without first learning to read the music signature, there is a clear implication that there is also a way to write Tablature intelligently without learning to write the music signature first. The guitar tuning signature is the information that is required both to read and write Tabs, but musical key signature is not required to learn guitar.

The archival field of music that is the subset of music written in Tablature notation for guitar has not yet achieved the intellectual standard established centuries ago for piano music literature. There are a number of problems reckoning guitar music intelligence in Tablature notation using only pitch value intelligence.

Guitar intelligence is defined here to mean those facts, knowledge and information required to read, write, and play guitar music, and to achieve guitar literacy and literature. Our invention proves that K-facts in L-sentences reduce to a binary code of 0 and 1.

There are several recognized problems in the guitar music intelligence state of art including:

1) Most guitar players do not read or write music and many believe guitar music is impossible to write accurately. 2) Music publishers face a difficult problem knowing how to depict guitar music in print without a holographic score. In general the publisher does not have and cannot acquire the guitar tuning signature that defines the guitar music L-language in which a seminal work of guitar is phrased. 3) The music user thinks the music phrased in print is the official version and does not realize the music publisher did not actually have a method to learn how to play the guitar music correctly or even how to re-phrase the music in print for guitar for a standard tuning but instead the publisher merely traces the outline of observed pitch onto the Tablature structure. Since the tracing is correct in pitch model but not guitar music, the user is “duped” into wasting time learning guitar that is not correctly phrased, thinking rote practice will eventually make the wrong music phrases right.

Finding the path that connects the wrong phrase to the right phrase is the basis for guitar intelligence pullback. As it turns out, guessing the path is difficult or impossible but finding the path by removing eccentricity of movement in a logic tree is a procedure for learning guitar that converges very quickly on the correct L-sentence phrase.

4) Seminal works of guitar are often published in different forms, suggesting publishers do not agree on how to correctly depict culturally substantial guitar music. Cannons of music composed and played on guitar are often published as trivially guitar-annotated piano music. An experienced musician can often tell music in print is not correct, but this is more difficult for the student. Special guitar learning is required to recognize imitation Tabs and if pitch is the only model for correct form, no one knows how to authenticate Tabs. If no one can determine whether or not guitar music is written correctly, perhaps, the guitar learning and writing industry reasons, it does not matter how guitar music is depicted. In this context, a method of proofing music for guitar is paramount to achieving literacy. Learning and writing do not make literature without a system for grammatical re-phrasing so that meaning and order are correct in the guitar model addition to the pitch model.

Tablature is an old method for writing music and had no substantial economic value prior to the Mel Bay Music Publishing Co., which began to publish Tablature music in the mid-20^{th} century. A number of companies publish quality Tablature and several do not. The industry reputation for intellectual accuracy is low both among guitarists and music academics. Errors in Tablature are common even in good transcriptions. Also, it is often uncertain why a publisher chooses a particular key, tuning, or position for a given pitch value.

The first machine used to learn guitar was the phonograph record player. Guitar learning machines that assist in writing music correctly using the observed pitch value and musical key do not output any guitar music intelligence because the pitch value and the musical key are the same for every guitar tuning and every guitar key.

Guitar intelligence machines currently available use only algebra (not L-space logic and not K spectrum 50 intelligence). Machines for learning guitar available today do not have a log space system of correcting errors that arise in Tablature notation using the guitar tuning signature and second-order logic. Today's guitar learning and writing industry is not using a grammatical apparatus that includes a square matrix of functions for logic, probability, geometry, algebra, spectrology, and graph theory that can benchmark a new intellectual standard.

A comparison between guitar and piano music intelligence is useful in clarifying the field of invention which guitar intelligence defines.

The guitar tablature-construction machine and the player piano mastering devices are the same in the sense that, in both cases, the human operator depresses on/off mechanical stops, like keys on a typewriter that writes the Tablature or the piano roll. Both the Tabs and piano roll vanish from auditory surveillance, and both could be discovered by visual inspection of the model elements. We can imagine, however, as a thought experiment, that the guitar stops the guitarist makes are printed as a record on a data strip of tape printed out by the guitar player operating the guitar printer, just like the piano roll mastering device prints out the piano roll like a dot-matrix, as a thought experiment.

In the player piano parlor trick, the guest is duped into thinking the host is playing piano in the next room. The guest can transcribe the piano music and then play the music on piano, but has absolutely no way to penetrate the piano roll intelligence. The piano music and piano score are directly connected but the piano music and music score are disconnected from the piano roll intelligence by the player machine. The piano roll player in effect plays itself according to instructions minimal on the piano model.

The piano roll perforations are like the IBM punch card, which like the notched card on the loom reflect state of system transitions that are binary (on/off) functions. The comparison between binary perforations controlling mechanical stops makes an argument the guitar is the oldest computable and programmable device.

This guitar player/player piano analogy is important because it formulates an argument that the guest could use the piano roll, and nothing else, not even the player piano, and still learn how to read and write the piano roll music script. An isomorphic copy of the player piano closure operation can be recovered from the field of perforation. In the same way, the guitarist uses the computable guitar and nothing else to learn guitar. An isomorphic copy of the L-language can be recovered from an adequate field of values.

The analogy between guitar and piano makes clear the difference in difficulty between cracking the piano roll code and cracking the tablature code: The piano roll is one-countable so if the pitch value of any one perforation is identified, then every piano roll perforation can be quantitated on the keyboard. But the tablature is two-countable because, given the correct pitch value index, the correct guitar position index number remains to be determined. That is why the pushdown automaton that writes tablature must be relaxed to allow that each pitch can map to more than one guitar position in a bipartite pitch-position graph. This observation invokes bipartite graph theory in which the relaxation of the pushdown automation for guitar is like a tea set with more saucers (guitar positions) than cups (pitch values), but none-the-less there is a square matrix of rules which show which cups match which saucers.

There can be several L-sentences in tablature that make the same musical statement in guitar model theory; written in an incorrect way Tabs may not generate the expected result. Paraphrasing L-sentence in Tablature never alters the harmonic relations definable on guitar, it only affect the Tablature used to define the observed harmonic relations.

A curious kind of gibberish (partial sense error) results when guitar music is written correctly by pitch but indexed incorrectly by guitar position: the music always proofs correctly by pitch on guitar, but the pitch is not correctly quantitated on the guitar because the index numbers of the pitch value set and the fret set are scrambled. The result of transcribing music using only pitch algebra is guitar music badly written, and a performer wastes money, time, and effort trying to learn use pitch intelligence to play guitar.

The guitar intelligence problem is a coding problem analogous to a cipher code with text-shift and text-substitution code rings. Transposition is a text-shift code, while tuning is a text-substitution code, that affects a text-shift that effects a generalized transposition for each string. The cipher means that, if you code and decode, the net result is zero: the cipher code vanishes like invisible ink.

The pitch model of music is a transposition theory in which the group signature is defined by the musical key, transposition, and octave inversion. The tuples are a generalized transposition system where there is an arrow between every possible music expression. The set of arrows has a distinct K spectrum 50.

A cipher expresses the idea of arrows in a vanishing field of zeros that make a closed algebraic field over the interior of the guitar model.

When transposition and generalized transposition are combined, pulling back the encrypted intelligence is more difficult, much like trying to reconstruct a three-dimensional image using a photograph. The value of the encryption key increases with each prime degree in the L-structure.

To crack the six-string guitar cipher code one needs a key function with more than the numbers indexing the observed key signature and observed pitch value sets. Also required for guitar intelligence is the index numbers for an arbitrary decoder ring with five non-reducible rings (guitar tuning intervals).

Unlike the pitch value index numbers that are ordinals; the octave and the tuning intervals are cardinal numbers. The ordinal index numbers reflect order but the octave winding number and the ring signature of the guitar tuning are cardinal numbers that reflect size not order.

The guitar and piano do not have the same cardinality and cannot therefore be related by an algebraic function that is one-to-one. In a three octave range the piano has thirty-six positions, the guitar typically has seventy-two positions. On guitar there can be up to five positions with the same pitch value. These isotonic L-redundancy sets have a strong K spectrum 50 fingerprint.

The guitar tuning “decoder ring” can use cardinal tuning intervals that size integral domain magnitudes to cipher the guitar tablature algebra using a geometric projection engine like a spectroscope that reveals transitions in system state as spectral images of favored frequencies in light. Cipher means the guitar position commutes but there is zero net change in observed pitch. The cardinal numbers in the ring make the transformation matrix.

Without the guitar tuning decoder ring matrix the transitions in the guitar state of system make no sense. But with the decoder ring cardinal magnitudes the user navigates the L-space and its L-tablature algebraic field constructed over the guitar fret board by the triangulating guitar tuning vectors as simple ABC cipher sums.

Understanding how tablature and music writing are related by cipher re-phrasing requires mastering writing both Tablature and music signatures in order to see that, while it is true that music and guitar music are similar and equal—meaning “a fact in music is also a fact in guitar music, and vice versa”—it is not true that music and guitar music are the same, or even closely related expressions of tonality.

In fact, music and guitar music are extremely disconnected, and not even the same mathematic category of objects. The guitar model facts—that are written using index set numbers that range over the elements of the guitar (or any other models)—are known only as products of the nullstellensatz and nothing else. It follows, then, that guitar intelligence only requires knowing the tuple matrix used as a geometric projection engine to operate the nullstellensatz. Nothing else is required to learn guitar.

The guitar intelligence model is used to recover the non-trivial guitar music topologic group intelligence, which is richer intelligence, from the music set, that is trivial intelligence, by an equation for triangulation. In other words, the nullstellensatz invention depends on the triangulation and triviality theorems in semi-algebraic systems.

Triangulation and trivialization connect music and guitar music which are extremely disconnected and would not otherwise be understandable as making sense and order without the method of L-construction and proofing.

Music mathematics, furthermore, uses an especially simple language that is based on a particular subset of semi-algebra, called a semi-linear algebra, which has the most elemental Boolean ring possible.

The use of “L” herein is restricted to the family of languages in L-space to which music belongs. “Semi-algebra” refers to system where problems cannot be solved using only polynomial algebra because they also require logic and probability.

A semi-algebraic, once defined, implies there is an existence proof of a complete algorithm. The complete algorithm has many representations including a lattice, a theory, a vector, a point, a dual, a graph, a spectrum, and other mathematic fields, and the algorithm can also be equivalently thought of as a book of rules for a game or language and as the set of instructions that initialize a Turing machine. In all these algorithmic structures, algebra alone cannot solve problems and mathematic functions by themselves can cause confusion when they do not conserve harmonic ratios in music.

In addition, in semi-linear algebraic mathematic fields, there is one and only one defined operation. The singular binary operation is at once an additive and multiplicative identity: This means “product” and “sum” are interchangeable herein because they have the same identity matrix. See the Octave Metric Proof.

David Hilbert discovered the nullstellensatz more than a century ago. If the vanishing point in a painting surprises, then the field of vanishing polynomials is astonishing. FIGS. 5A-5D illustrate the inverse concepts of vanishing point and perspective projection which are related by a fundamental matrix. Questions about whether the guitar nullstellensatz has a computable matrix formula are easily resolved because only discrete first-order polynomials are used, which is the lowest order Boolean algebra possible (except the empty set).

Even though Tabs are obviously computable, a proof of computability is required since no one seems to understand in what field the machine that constructs and proofs Tablature is found. Heretofore, no one can say how to operate the guitar intelligence machine to reconnoiter a path for learning guitar better and faster. No one at the present time can state the instructions for music axiomatically, so no one can compute Tabs in the industry.

An existence proof in mathematics means a proof that a solution to a problem exists and the proof shows others the solution can be found.

The existence proof herein shows the L-sentences in music are understood by K-facts that are used in a simple way by following ordinary geometric diagrams and simple equations because they can be represented in a natural topologic way that makes sense in the interior of the guitar but not exterior to the tuning space.

### DEFINITION OF TERMS

Mathematic terms used herein correspond in all cases to the established definitions of those terms in the mathematic literature. Musical labels are added to mathematical terms, symbols and function as a subscript but do not alter the mathematic definition. For example, the guitar tuning vector is a mathematic vector whose coordinates are the tuning intervals (interval summation), such as the Zariski Topology vector for the six-tuple G=(F₀, F₁, F₂, F₃, F₄, F₅).

Guitar intelligence is lost upon intonation at specific pitch but can be recovered using the commutative square matrix of the left adjoint free functor, which inverts the forgetful functor in the forgetful diagram.

Our Tablature Proofing Turing Machine:

Step 1) Gödel's Theorem sets forth every consistent, countable first-order theory has a finite or countable model. Proofs are finite and sound. If T(G) is a finite set of L-sentences, then there is an L-algorithm that, when given a sequence of L-formulas Fᵢ and L-sentences A, will decide whether F is a proof of A from T.

Step 2) “If L is a recursive language and T(G) is a recursive L-theory then {G:T is proof of G} is recursively enumerable; that is, there is an algorithm that when given the signature of G as input will halt accepting if T(G) is proof of G and not halt if T(G) is not proof of G. Proof: There is a six-tuple guitar tuning G=(F₀, F₁, F₂, F₃, F₄, F₅), a programmable and computable listing of all finite sequences in G. G is a subset of all tuples, and tablature is a subset of G.

Step 3) Standard mathematic construction of a Tablature-Proofing Turing machine can be accomplished in different but equivalent constructions, including: i) Henkin Construction is a method of defining an object using only limiting values of 0 and 1. The object of Henkin construction is to constrain language L so that every element of the model is named by a constant symbol, 0 or 1. “Henkin construction” is the standard mathematic method of constructing a model where the universe is built from constant symbols. Theories like music that have a witness property (i.e., intonation at specific pitch) are said to be “Henkinized”.

ii) The algebraic geometry method of K-construction of algebraic closed fields using Chevalley's Theorem. The K construction uses a k-tuple so for guitar the tablature is a six-constructed algebraic field over a six-tuple.

iii) The method of projecting semi-algebraic sets to make a new topology using the Tarski-Seidenberg Theorem. When the elemental isomorphic musical graph is drawn in a field, the diagram can be used under projection to make any L-structure using any k-tuple.

iv) The method of constructing an algebraic closed field using a nullstellensatz, which is a field of vanishing polynomials that connect tablature and music, and more generally all geometric and algebraic fields.

v) The guitar is the union and intersection of the clopen guitar string (Baire Existence Proof) is non-reducible construction because there is no set smaller than the strings that can cover the guitar except [0, 1].

Step 4) The Zero-One Law of Graphs states that a theory is completely decidable if every element has a limiting value at infinity of 0 or 1. If the L-language is constructed using only values whose limit is 1 or 0, the L-language is decidable.

Step 5) The principle of projectile invariance (Desargues Theorem) states that harmonic relations in a field are constant in every projection, but angles, distance, and geometric shapes formed by notes and interval are not constant under projection. This means the geometry of guitar is a function of the tuning projection and not the music. The principle of closure is basic to understanding tonal expression in music, and according to the Fundamental Theorem of Projective Geometry there is one and only one projection (closure) between any two isomorphic fields.

Step 6) Subsets of Rn, called n-tuples, in the real closed field are complete and recursively axiomatized, and decidable.

Step 7) Quantifier elimination is a method for the real closed field that promises a useful geometric diagram and a natural arithmetic. The pitch model and guitar model are complimentary structures related by witness function.

Step 8) A semi-algebraic set is the finite union of point and intervals in the real closed field, such as notes and intervals in music.

Step 9) Let L={E}, where E is a binary relation, and let T(G) be the theory of an equivalence relation with exactly two classes, both of which are infinite. The equivalence classes are defined as the sets {pitch value} and {guitar values}. Therefore, any two countable models of T(G) are fields isomorphic to L. This defines a complete lattice with two algebraic sub modules and one log space logic module.

Step 10) Tarski developed the method of quantifier elimination to show that all subsets definable in the real closed field are geometrically well-behaved. Therefore the elemental Boolean ring has a simple diagram that can be discovered by inspection. Wilkie showed the exponential field is also decidable in 1996.

Step 11) The real line and exponential functions have in common, at most, a single point which can be used to show the guitar is continuous at every point in the construction. (See Octave Metric Proof.)

Step 12) According to affine theory, pull back of guitar intelligence is impossible because intonation is a forgetful functor. (See Forgetful Diagram, FIG. 3H.)

Step 13) Observe the three spectral images of guitar, P 30, Z 40, K 50. P(G) is defined by G=(F₀, F₁, F₂, F₃, F₄, F₅) where the vector coordinates Fᵢ are defined by the interval between a string and the adjacent lower string. Z(G) is defined by G=(F₀, F₁, F₂, F₃, F₄, F₅) where the vector coordinates Fᵢ are defined by the interval between a string and the system fundamental. (summation of intervals up to the string union).

K spectrum 50 is any non-trivial order. The K12 cycle of musical keys on guitar can be stated as a bipartite subgraph of the form G=(F₀, F₁, F₂, F₃, F₄, F₅) because there are infrequently more than six useful guitar keys.

Step 14) Observe that L-space graphs in log space are orthonormal (isomorphic) abstract dual graphs that can be projected onto a plane in a useful diagram. The orthonormality between collections of edge sets makes the intersection patterns between fields sufficiently similar that the cycles in one L-graph can form bonds in another, and vice versa. This means that L-graphs in music can move their edge set to an entirely new set of vertices, redefining incidences in such a way that precisely those edges that used to form cycles in the graph now form bonds, and vice versa. This is the principle of isomorphism in projections, the precise arrow of projection that relaxes the mechanism of the pushdown automaton.

A pushdown automaton is defined as a singularly algebraic music writing machine that uses a fixed one-to-one pitch-position equivalence and cannot re-phrase. Therefore the pushdown automaton outputs zero guitar intelligence because it cannot proof L-sentences. L-space thinking rectifies partial sense errors in tablature sentences that result when only pitch intelligence is used to understand guitar without re-phrasing arbitrary construction. FIG. 3E shows how right pitch/wrong position missense error is logically rectified to right pitch/right position.

The metric space proof of topologic existence in L-space is proof that you can store a polynomial-magnitude number in log space and use it to remember pointers to a position of the input and output index numbers in the guitar model.

The log space metric proof of existence shows all music topology is subject to the same metric under the same octave closure operator that can be modeled in log space by adding a commutative lattice isomorphic to the log space. The guitar lattice, whose signature is the intersection and union of the strings integral domains defined by the Baire theorem, proves there is guitar intelligence pullback with a left adjoint identity matrix.

The left adjoint identity matrix is the product of the octave identity matrix, that is the first-order product set of [0, 1]. The first-order Boolean operator is the lowest order in an infinite series of higher Boolean rings that are not defined in music.

The fact that T(G) uses only first-order (semi-linear) polynomials means that T(G) is the most minimal deterministic Turing machine possible.

To operate the T(G) invention a machine such as a computer, or a human operator proceeds through tablature or music input, performing stepwise operations, writing or erasing using algebra, probability, and logic, frame by frame from beginning to end, sometimes moving back and forth to smooth the path of tone movement that must work with what comes immediately before and after any given fret position number vector. Our invention T(G) is operated in a simple way using the twelve T(G) members embodied here: 1) guitar, 2) guitar intonation, 3) pitch value set, 4) musical key, 5) guitar tuning, 6) guitar key, 7) guitar fret board matrix coordinates (string, fret), 8) tablature notation system, 9) Open Lattice of the Musical Key Topology (OLMKT) algebraic closure operator, (OLMKT is the product of G and the Musical Key Topology), 10) a machine such as a computer (or potentially a human) operator, 11) tablature manuscript paper, 12) pencil and eraser if a human operator.

Reading and writing music and knowledge of pitch intelligence are not required, and the pitch value numbers are known internal to the guitar by counting on the guitar beginning at F₀.

The operation of tablature-proofing does not require knowledge of music theory, or graph theory, but at any time the operator can always check T(G) output for correct form in several ways, including by pitch intelligence theory. (called harmony).

When the computable algebraic, probability, and logic instructions in the algebraic closure operations are computed, the user then further proofs the music by playing the new music output on guitar, which invariably results in finding additional smaller residual errors that are not initially recognizable to the proofer, which hones the output to an optimized subset of all possible expressions. Eventually every L-proof in given L-language is mastered, and L-literacy is achieved.

Some tablature problems can be solved on paper using the graph eccentricity to keep notes within the compass of the fingers, but there remain problems that can only be solved with guitar in hand.

Three types of guitar intelligence learning machines are possible: 1) machines that aid in writing correct pitch values, by recording sounds and perhaps pitch transduction, filtering, or signal analysis of continuous functions, including by slowing music down at constant pitch; 2) machines that input correct pitch and then write tablature according to the algebra of the guitar tuning rings but without using L-space trees, orders, lattices, products, logic, probability, or geometry to find the best path to solutions; 3) machines that use the non-trivial equivalence relations between the pitch values and guitar values.

Machine types #1 and #2 described above are pushdown automatons. Machine #3 is our invention that constructs and proofs tablature.

Projection and perspective are fields of arrows (sheafs) that make a guitar tuning projection into a geometric engine of projection for sound intonation analogous to a camera for light. Music theory is a collection of topologies; and guitar theory is a collection of tuning topologies that are connected by sheafs of arrows. (See FIG. 7.)

The mathematical principle of our invention for constructing and proofing tablature is:
“A set of prime ideals in the signature of a Boolean algebra can be made into a topologic space in a natural way which has a useful geometric interpretation, in which the open sets correspond to the arbitrary ideals of the algebra. Specifically, to an ideal musical key, we associate the open set of all prime ideals that do not contain the musical key. In this topology, the clopen sets (those that are both open and closed) correspond to the principal ideals, and hence to the elements of the algebra; so we can recover an isomorphic copy of the original algebra from its space of prime ideals.”

The elemental atomic L-diagram in music can be discovered graphically. This exercise is illustrated in FIGS. 3A-3I. See also Henkin Construction in FIGS. 7, 8, and 9 which show how an orthonormal matrix is defined. When the method of the first two steps is established, the user will find the remaining steps in construction are recursive. Algebraic fields are illustrated in FIG. 11.

The left adjoint diagram is illustrated by the forgetful diagram, which is a commuting triangle (See FIG. 3H), and by the free square diagram, which is a commuting square (See FIG. 3I). The left adjoint functor is by definition a morphism (an arrow) in the nullstellensatz algebraic closure operations. The left adjoint functor is important because the commuting square can be used to recover what otherwise seems to be lost.

The “left adjoint” matrix relationship may be visualized in a simple way, meaning if intonation is an arrow to the right that forgets the guitar music, then the left adjoint matrix product is an arrow to the left that remembers the lost guitar intelligence.

Intonation is an example of the property field of vanishing polynomials in the nullstellensatz field that can make something seem to disappear depending on one's point of perspective.

The K spectrum 50 non-triviality order can be compared to the cryptologic method of cracking a cipher code using the frequency with which symbols are used and then matching the observed spectrum to the known spectrum of a given language. The K-probability distribution of the elements in the code is important intelligence for reckoning the adjoint matrix.

Cipher is a cryptologic term that is used herein to capture the mathematic concept of a commutative matrix (or lattice). The cipher is an algorithm, used twice, that makes something vanish and reappear with zero net change in value. The cipher reduces something substantially non-trivial to something substantially trivial (Triviality Theorem), and then the cipher makes the trivial back into the non-trivial (Triangle Theorem). Without the triangulation and trivialization theorem arrows, the problem of extreme disconnection between music and guitar music cannot be solved because it is too difficult to find the binary path connecting different L-structures.

The first existence proof was made by Euclid who showed how to triangulate a step-by-step path to find the least square common to two given squares. The least square problem has no algebraic formula as a solution but still the least common square can always be proved by an algorithm in a finite number of steps. In Euclid's least square existence proof, one is instructed go between rooms writing and erasing calculations about squares that initially are guesses, but step by step the calculations that must converge arbitrarily on the best-possible proof in a finite number of steps, which is the last entry written. The solution may, however include the null set, meaning no solution exists. No solution is not the same as an undefined solution that prevents the proof from halting. An empty solution set is not a trivial solution because the null solution set is still a useful proof, just as in the least common square method knowing there is no common square saves money, time, and effort by discontinuing the search procedure when a solution cannot be found.

The important point in a complete algorithm (for a halting proof) is that regardless of how every many steps are required in an operation, the calculus always halts if the algorithm can be recursively enumerated as a list of instructions using finite sets of index numbers in a way that is mathematically complete. Completeness is also called two-countable. L-space is always complete, and any space isomorphic to L-space is also complete. L-space can be usefully but not accurately drawn in an optical field of view.

Just like Euclid, the method of constructing tablature is to first make an arbitrary guess about the correct Tab for a given pitch and then go back-and-forth between cells comparing calculations that must converge on an answer for the best position given pitch.

The procedure for learning guitar is therefore graphable as a two-countable multigraph with a common endpoint: first pitch is given, and then the guitar position is rectified or squared as a constructible proof. According the principle of the semi-algebraic triangulation, any semi-algebraic problem, however complex, can always be decomposed into smaller triangles that are easily understood.

The left adjoint is a cipher function in the nullstellensatz closure operator that “zeros out” the forgetful functor. When the nullstellensatz product is witnessed on intonation (witness means an image of the abstract nullstellensatz graph embedded in a plane as a R² graph is either visualized, or an image of music embedded by projection onto the plane of the tympanic membrane of the ear is heard), the image of music is always perceived as if music intelligence is a trivial set of note points and note intervals that fall on a straight line (or curve or surface) defined by the mathematic function of pitch in the frequency domain.

The spectral nature of pitch is clearly a three-dimensional ABC object, not the two-dimensional image of the object, because the frequency domain cannot be resolved to a point, according the Spectral Resolution Theorem. The harmonic structure cannot be defined inside the frequency domain. The problem of spectral resolution leads to the Stone Natural Representation Theorem, which illustrates that the music topology has a natural representation.

According to the Stone Natural Representation Theorem, there must be a key function vector connecting the system fundamental to its domain. Therefore the system fundamental is not topologically represented inside the frequency domain, but instead F₀ is a direction and a unit of distance orthogonal to the real number line of the frequency domain. This concept is illustrated in FIGS. 8 and 9.

The distinction between FIG. 8 and FIG. 9 is important because in the first step, as shown FIG. 8, adding the system fundamental, by itself, does not define the multiplicative and additive identity of F₀, but in Step 2 of the Henkin construction, FIG. 9 shows the octave identity matrix is defined as an orthonormal matrix by the simple geometric diagram. It follows from FIG. 9, that those structures built upon the system fundamental as a point of origin are also metric field structures. The metric field structures in music are ABC objects that are not inside the frequency domain per se.

Instead the music topology is external to the real number line but acquires the decidable properties of real numbers through the key function that spreads decidability throughout the interior of any model constructed by the intersection and union of clopen sets. FIG. 9 shows how music is a metric space topology isomorphic to the product set of {0, 1}.

All subsets in music have the same metric space, the L-space metric, where every distance has a limit value of 1 or 0.

The perception that music intelligence is inside the frequency domain is a profound illusion supported by the fact that real analysis in harmonics is successive, predictive, but the pitch theory of music is not simple, complete, or defined. The theory of light has the same problem.

Real analysis is acceptable when music is reduced to points and intervals on a line or a curve, or even a surface, but neither the theory of real numbers nor the theory of integers applies to L-space languages in higher-order intelligence.

Frequency and pitch are monotonic, continuously rising functions which make the concept of tonality seem shallow, when in actuality tonality is expansively higher-dimensional. One may perceive that tonality is a line or a surface but rather tonality is a three-dimensional ABC monadic object. (Monotonicity Theorem states that if a function f:(a, b)→R is definable then f is continuous on each interval and either constant, strictly decreasing or strictly increasing on each sub-interval. FIG. 3K confirms this diagram: the tonal movement by string and fret is strictly decreasing or increasing while the tone movement on the isotonic line is constant.

The Musical Monotonicity Theorem, demonstrates the value of naming mathematic fields by adding musical labels to the mathematic definition. The Musical Monotonicity Theorem proves intonation fields are three-dimensional projective structures with SO3 symmetry.

Mobius was the first to observe that, in order to understand an ABC object in three dimensions, there must be one higher dimension, a fourth dimension, that is required to understand musical objects mathematically and therefore must exist even if the space is not intuitively-structured. Thinking in the fourth dimension requires either special learning or a book of rules. (or both).

A fourth dimensional direction in music theory might seem an impossible path to construct, but in fact the path must connect in a continuous way if music theory is complete. Music topology is Hausdorff if music theory is complete, meaning music is compact in mathematic language. Compact by theorem means there is a left adjoint. Compact is 1-step below computable, which requires an operating system.

By triangulation of a ABC structure, one reconstructs the higher dimensional intelligence, because the points in the field carry with them an image of the D-neighborhood and the projection space in which they are originally defined by an algebra of meets and joins defined by prime ideals. By trivialization, one can reduce higher intelligence to the limit value of pitch. By the algebra of meets and joins, called a Heyting Algebra, it is possible to build the lattice, which is illustrated as a scheme in FIGS. 11 and 12.

For instance, one can triangulate the system fundamental and the string fundamental with the fret number to calculate the pitch value, which is illustrated as an ABC triangle. When the pitch value is intonated the triangle is trivialized: ABC and its truth structure “disappear” and there is no way to know how the note was calculated by the guitarist without the truth structure intelligence.

The phenomenon of “forgetting the musical key” is a principle in Affine theory that depends on the fact that intonation is a witness function that quantifies music at specific pitch and musical key. Since the observed music does not depend in anyway on its truth structure, Affine theory implies that the truth structure is not accessible to guitar intelligence pullback when in fact the truth structure can be recovered up to the point of isomorphism. That is, the tuning can be recovered by surveillance, but the intonation per se, cannot. The guitar intonation level equivalent is inferred, by the difference between observed and predicted guitar keys.

A theory that has a witness function is said in mathematics parlance to be “Henkinized,” which is one of the standard mathematic methods for making a Turing machine out of 1s and 0s. If the system reduces to the set {0, 1} then it has a decidable truth structure. According to the forgetful diagram (FIG. 3H) (commuting triangle), intonation is the forgetful functor that Henkinizes music theory.

The method of quantifier elimination and quantification is a valuable tool for making a Turing machine that always halts. Quantifier elimination, used herein for elements of models like tablature and guitar, was originally developed by the Polish mathematician Alfred Tarski in order to prove that subsets of Rⁿ, subsets which are called “n-tuples” or just tuples, are decidable in the metric space of the real closed field. The n-tuples in music theory are the subsets of the musical key product set (a product set of the sequence S₁₂=1) which is the family of open subsets of the musical key. For example, the guitar tuning for six-string guitar is a five-tuple, which has two equivalent expressions: the Pierce Spectrum of prime tuning intervals, or P spectrum 30, and the Zariski Spectrum 40 of tuning prime numbers of guitar, or Z spectrum 40 of G Z(G). The Z(G) is the summation of the P(G) spectrum 30, so Z 40 and P 30 are equivalent perspective projections by the guitar spectroscope that are graphed in different ways. (FIG. 2). For instance, if the guitar tuning is P(G)=(0 5 5 5 4 5), then it follows by definition Z(G)=(0 5 10 15 19 24), and will be observed to be K(G)=GCEADF at E2 intonation. This K spectrum 50 is so universally-known and accepted that guitar teachers use the vector as a mnemonic (more commonly stated CAGED) to orient students to the tuning space of G=(0 5 5 5 4 5).

The spectral images of the guitar tuning Spectrum P 30 of G=(0 5 5 5 4 5) and the tuning summation Spectrum Z 40 of G (0 5 10 15 19 24) are the well-known spectrograms for a popular guitar tuning, called a “standard tuning” because its usage is so prevalent in literature and common use.

It must be recognized however that Standard Tuning is by no means the best tuning and cannot serve as a substitute for all other guitar tunings which are also important. Publishing all guitar music in one “standard” guitar tuning leads to the impression that all guitarists use the same tuning, which trivializes guitar tuning intelligence.

The study of the P, Z, and K spectrums (30, 40, 50 respectively) in music is defined herein as the field of musical spectrology.

Music theory is a spectral theory as opposed to a pitch theory of sound. Frequency cannot explain tonality by real or integer analytics, only why tonality is constructable and proofable in a natural way. It is a mistake to confuse polynomial subsets of n-tuples in Rⁿ with their trivial isomorphic graph in the R² coordinate plane.

Music is frequently observed in a plane defined by the pitch value and musical key tone net, which is an L-fact first observed by Euler, that misleads observers into thinking that music theory has a planar or toroidal closure. (See comparison of spherical and toroidal closure in FIGS. 4C, 4E1-4E3.)

A simple example illustrates how spectrology and graphology may be combined as tool in a practical application for guitar learning applications. In the (0 5 5 5 4 5) tuning (the tuning consistently used herein), the pitch value E4 has five equivalent note positions on the guitar. The line connecting the E4 pitch values on guitar extends from the lowest note on the highest string intersecting with the 4 adjacent lower guitar strings that also contain E4.

“E” is the pitch value octave tone class ordinal index letter (there are twelve tone class index numbers) and four is the octave cardinal winding number which determines the octave magnitude of E. (FIG. 4B).

Graphology, which is the study of the E4 isotonic graph shows the line of constant pitch for E4 constructed in the (0 5 10 15 19 24) Zariski Guitar Topology, called the E4 isotonic line of G, is the line that connects the five notes on the guitar tuning model with the same pitch value element E4 (guitar intonation witnessed at E2) which must be orthogonal (perpendicular) to the fret board.

The isotonic E4 line in graph theory must be perpendicular to both: 1) the line of movement by string, and 2) the line of movement by fret, because for directions 1) and 2) the index numbers are strictly increasing or strictly decreasing because the pitch value index numbers move in the same direction as the string and fret value index numbers. This proves the E4 isotonic line of tonal movement is not in the 1) direction nor in the 2) direction because in direction 3) on the isotonic line the fret index moves contrary to the string index while the pitch remains constant.

The above proves that tonal movement has three degrees of freedom. This proof applies to all music because it illustrates the Music Monotonicity Theorem in music semi-linear algebra, which is the fundamental theorem of music.

Therefore, tone movement on the E4 isotonic lines is not by string nor by fret, but instead by a composite function of both string and fret. This fact is illustrated in FIG. 3K (three Directions of Movement on Guitar Fret Board S, F, and S∘F). S∘F is the SO3 composition function of String and Fret that defines the isotonic line. The graph in FIG. 3K is surprising conceptually and difficult to visualize since S∘F can only be drawn as if there is a 45 degree angle, which a useful diagram but not accurate because the 3^{rd} direction is projective and not Euclidean.

Study of the E4 graph (FIG. 3K) shows that music has three-degrees of freedom, not two as commonly thought. Therefore it is a proven fact that music is a three-dimensional ABC object, called a monad, and therefore a two-dimensional depiction of music in a graph is a projection that embeds ABC in a plane, just as a camera embeds a 3-D object as an image on film.

The E4 isotonic line has a characteristic K spectrum 50, probability weighted average, so that the E4 isotonic line is a weighted graph. Music graphs are multigraphs that assign every edge to one or two vertices. The multigraph connects graph theory to affine forgetting because the multigraph is a directed graph with forgotten edge directions.

Notes on progressively lower strings/higher frets on the E4 isotonic line are progressively less favorable and therefore each more distal occurrence of E4 on the line is progressively less probable in usage, until finally usage of the last E4 value on the second string at fret 17 will have a negligible probability of usage meaning the note is invariably proofed a false construction. On some guitars the note at string 2 fret 17 would be definitively beyond the compass of the fingers, on other guitars the note would be only slightly difficult to reach.

The pattern of diminishing probability of use in the K spectrum of the E4 pitch value set along the isotonic line is characteristic of the guitar tuning, but will broaden somewhat with greater mastery of the second and third positions on guitar.

K spectrum 50 facts typically broaden somewhat with greater literacy. First a musician commonly learns the Key of C which has no sharps or flats, latter the musician extends the key spectrum to keys with more accidentals. The progression of music intelligence moves, in this case, along the circle of 5ths in either clockwise or counter-clockwise direction. On guitar, the development of L-intelligence follows the binary path to make new proofs in new tunings and new keys. Even when a musician masters all the keys in the circle of fifths, the characteristic image of the K spectrum 50 fingerprint pattern is never lost. When every key signature is mastered, the preference for keys with fewer accidentals will still remain.

A one-string instrument is the non-reducible clopen set of topology of L-languages in Log space. The one-string musical key shows K spectrum 50 predilection for the musical key internal to the string that is the same as the one-string fundamental F₀ (Key 0). Key 0 will remain the favored one-string key, even though every one-string key is theoretically equivalent and should have equal probability of use. Since every musical key in R² is equivalent, the observer trivializes the string key intelligence as not important, which might lead to the incorrect conclusion that every key on guitar is equally probable in spite of the observable and unequivocal K spectrum 50 evidence to the contrary.

In two-string L-languages, the interval between strings has a strong K spectrum 50 strictly in the range of two to seven, where five is the most common tuning interval and two least common tuning interval in the P spectrum 30. The Z spectrum 40 shows a strong predilection for the twelve and twenty-four pitch values to fall on the third and sixth strings as octaves.

The predilection for the interval five in the P spectrum 30 is clearly a reflection of the nominal size of the guitar relative to the size of the human hand that intends to map one finger to each of four successive positions on a string before moving to a higher string. The guitar magnitude is distinct from violin which intends to map one finger to one diatonic note, which requires six successive notes on one string before moving to a higher string.

In writing tablature, the K spectrum 50 E4 intelligence is useful because the Tab proofer knows the rule that the higher the string number, lower the fret number for the E4 pitch, the greater the probability the note is correct usage in both pitch and position. It also informs the Tab writer that a more advanced guitar player may expect to use the lower string values and higher fret numbers for E4 more often than the beginner. This is the same as saying the advanced guitar player is more likely to advance to the 2^{nd} and 3^{rd} guitar positions as learning progresses.

The isotonic line is also used to solve the problem resulting when an algebraic operation causes two notes to fall on the same line. The logical solution to the two-on-one position problem requires moving one of the notes along the isotonic line to an equivalent pitch value, which does not change the pitch but does relax the guitar syntax and semantics.

When the one-to-one relation of pitch and position is relaxed to a redundancy of about 50 fifty percent, a sophisticated predicate tablature logic is defined that is expressive and original but also an increasingly difficult logic to master. As the guitar language truth structure requires a larger number of inductive proofs to establish the identity matrix, it becomes critical to establish that Tablature is in fact computed efficiently so that guitar intelligence can in fact be learned in simple first-order polynomial time.

It is precisely the isotonic line in general that relaxes the pushdown automaton, which is the procedure and path that converts pitch to guitar position in a one-to-one algebraic function that solves the problem of guitar position symbol redundancy. The number of solutions to Tablature computations would be very large (2ⁿ), if not for the isotonic line which creates a very small subset of computations in a logic table square matrix. The degree of the isotonic line is the degree of the identity matrix truth structure for the pitch value of the line. (Observe that E4 is a pitch value point that is extended on guitar as a line internal to guitar which can be seen, but not heard, as tonal movement without change in pitch.

Guitar intelligence facts once proved for tuning G, remain facts proven true internally to tuning G. The L-sentence proofs in Tablature are consistent and sound, and do not have to be repeated every time a problem is encountered. For instance, the rules for guitar tunings apply to every key on guitar; this means that learning to transpose the key two steps up, will allow any key to be move up two steps (without accidents unique to each key). The two-steps-up transition using the (2 2 2 2 2 2) vector addition is a transposition calculus on the guitar tuning and disconnected from the musical key. The accumulation of facts about the interior of guitar collected in sum by Tablature computation make the Tablature operator the owner of a guitar grammar book of guitar tuning proofs for Tablature, which is a system of mathematical proofing

Theories like guitar that have a witness function (intonation at concert pitch or some other pitch) are said to be “Henkinized” when the theory can be constructed as a model where the universe of guitar or Tablature is built (or grown) from constant symbols.

In Tablature the constant symbols are fret numbers and string lines. There is a pitch-position equivalence relation for Guitar G that is defined as E=(frequency, pitch values, guitar model) where the guitar model is a constant closed field. In turn, the pitch-position equivalence E defines internal algebraic language of guitar:

More explicitly, Tablature is a system of indexing three disjoint sets. Disjoint sets means sets that have no elements in common except the end points 0 and 1. In music, disjoint sets make multigraphs.

The pitch-position index number equivalence relation E is: E=[{pitch value index numbers}, {fret position value index numbers}, {string position index numbers}]

Using the symbol # to mean “is equivalent to under E” this equation may be written PV# FV which is read “pitch values are equivalent to fret values”, but a better representation is the non-trivial ABC triangle equivalence relation PV-SV-FV, which reads as “pitch values are equivalent to fret values according to the string value”. The ABC triangle (PV, SV, FV) has the equational representation of this monad on guitar expressed in the equation “Pitch Value Vector=Fret Value Vector+Summation Vector.” The equation can be viewed as a vector sum or vector product because only one operation is defined. The equation is confirmed by direct observation: the equation states the pitch value at a given fret and string position on guitar is the pitch value of the unfretted string plus the fret number.

The signature of the guitar tuning is a set of prime number vector coefficients that are the encryption key to the identity matrix formula. The tuning primes are numbers known only as products of the tuning rule and the system fundamental, while every other value is triangulated as a product of the given value, the system fundamental and the string fundamental.

The pitch values are indexed by the system fundamental, the fret values are indexed by the string fundamental, and the string positions are nominally indexed by the first string. But the actual intonation value of the string is not determined by the index number but instead by arbitrary and non-decomposable rings in which the intervals between the strings are the prime ideals of the guitar tuning space.

“Arbitrary prime ideals of the guitar tuning theory” means one cannot determine what the guitar tuning is without special learning. “Non-decomposable rings” means the intervals in the guitar tuning P vector of G cannot be reduced to the union of any smaller sets than the indivisible strings, and still make the guitar a union of open and closed sets that form a proof of a Turing machine.

An important principle is that a guitar musician only wants to spend time, money, and effort learning to understand those musical intonation fields in music that are golden, as demonstrated experimentally in the non-trivial K spectrum 50. Musicians do not want to waste time learning guitar intelligence that is not proofed as optimal intelligence. The K spectrum 50 space is a grammar book for correct syntax and sematic structure in music. The object herein is to inductively learn the truth structure of the guitar language in order to obtain something useful about guitar music.

The Baire Category Theorem is the Fundamental Theorem of Music Theory that is a unifying principle for all music, including guitar. The Baire Theorem states that the guitar interior is a union of the strings and the guitar closure is the intersection of the guitar strings.

The manifold manifestation of the Baire Existence Proof can also seem to confuse a musician rather than unify music, precisely because the Baire Theorem can be usefully stated in so many ways that sound completely different. The same is true for the Tablature algebra—there are nearly endless variations.

The Baire Theorem says the topologic union of clopen sets, those sets that are both open and closed at once, makes a decidable system. The theorem says the closure of the system (read tonality) is the intersection of the clopen sets. This statement connects n-tuples and equations to an algebraic field of the nullstellensatz.

The various methods of proving a Turing machine (as algebraic fields, vector spaces, triangles, nullstellensatz, and on ad infinitum) allow a user of the apparatus to hone their skills by going back-and-forth between different models. (especially between tunings).

### BRIEF SUMMARY OF THE INVENTION

Guitar music is metricized by the Baire Category Theorem, an L-space existence proof for the Tablature-proofing Turing Machine T(G). T(G) quantifies the guitar model in sentences constructed using first-order predicate logic. Music spectrology and graphology use a guitar language signature as a geometric engine of projection that predicts how subsets of the musical key topology in Rⁿ are embedded in R² coordinate plane by projection. K spectrums are T(G) collections of inductive non-trivial L-facts proving tablature is computable to use K-facts to pullback guitar intelligence.

In providing such a touring machine it is:

An object to provide a method for transforming written music from a first state for playing on a first musical instrument into a second state for playing on a guitar comprising providing a first visually perceptible musical score in a first tuning in a first key for playing on a first musical instrument by a human; providing an algorithm implemented by a machine; and inputting the first visually perceptible music score into the machine which generates as an output a second visually perceptible musical score in a second tuning in a second key for playing on a guitar by a human.

It is a further object to provide a method for transforming written music of claim 1 and wherein the algorithm first defines an S spectrum of prime ideals elements of the first tuning; the algorithm second defines a Z spectrum which is a summation of the S spectrum of prime ideals elements present in a musical key product set of the first tuning; and the algorithm third, for any set of intonation values, defines a K probability spectrum by counting the usage of each element in each musical key product set.

It is a further object to provide a method for transforming written music wherein the algorithm uses K-Spectrum facts collected from the K spectrums to construct a library of L sentences in a log space family of L languages, and the L sentences are proofed in L tablature notation using K spectrum intelligence.

It is a further object to provide a method for transforming written music wherein the algorithm uses K-Spectrum facts to proof L-Sentences according to an identified guitar signature.

It is a further object to provide a tablature proofing turning machine for transforming written music from a first state for playing on a first instrument into a second state for playing on a guitar comprising an algorithm implemented by a machine that always halts on the best harmonic set element, and self-learns beginning from an illiterate state and hereafter learning how to play, write, read, edit, and proof guitar music to the point of intonation at a specific pitch.

It is a further object to provide a touring machine wherein the touring machine overcomes the problem of losing the musical key and tuning by affine projection using a language level structure of knowledge.

It is a further object to provide a touring machine wherein the machine makes guitar music more authentic, reproducible, and reliable.

It is a further object to provide a touring machine wherein the machine saves time, money and reduces effort required to learn to play guitar.

It is a still further object to provide a touring machine wherein the touring machine permits transformation of piano music literature into guitar music literature with accuracy and a high intellectual standard.

### BRIEF DESCRIPTION OF THE DRAWINGS

FIG. 1 is a flow chart of our guitar music intelligence invention showing the steps in order.

FIG. 2 is a graphical illustration of the Pierce, Zarski and Keimel Spectrums (P, Z, AND K Spectrums) arising from Guitar tuning theory G and showing the equivalency.

FIG. 3A-3M show visual representations of music graph theory.

FIG. 3A is a pitch-position multigraph showing Boolean Algebra Idempotents of Octave, Identity and Filter.

FIG. 3B is a pitch-position multigraph showing an Equilateral Octave Right Triangle.

FIG. 3C is a pitch-position atomic L-diagram multigraph showing the Pitch-Position Sub Filter.

FIG. 3D is an artist's visual representation of a Logic Square Table.

FIG. 3E is an artistic representation of a Hasse Diagram of Log Space.

FIG. 3F is an artistic representation of Euler's Tone Net shown as an L-space Hasse diagram.

FIG. 3G is a graphic representation of our guitar intelligence pullback.

FIG. 3H is a graphic representation of a left adjoint diagram illustrating a forgetful diagram.

FIG. 3I is a commutative lattice showing the left adjoint vector.

FIG. 3J is graphic representation of curve-lifting topology;

FIG. 3K is an artistic representation of the directions of tonal movement on a guitar fret board showing that position movement by string and fret is increasing or decreasing while tone movement is constant.

FIG. 3L is a graphic representation of the three equivalent transposition vectors.

FIG. 3M is a graphical illustration of a complete lattice (with one logic sub lattice and two algebraic sub lattices) showing the directions of movement.

FIGS. 4A-4E3 show the Music Topology Manifolds.

FIG. 4A is an artistic graphical representation of pitch-position equivalence E in R³ projected on R² coordinate plane.

FIG. 4B is an artistic representative of an octave winding by numbers.

FIG. 4C is an artistic representation of a spherical manifold.

FIG. 4D is a visual representation of pitch value and musical key observed in an R² coordinate plane.

FIG. 4E-1 is a visual representation of Euler's tone net torus showing toroidal closure of music theory.

FIG. 4E-2 is a cross section of Euler's tone net torus of FIG. 4E-1 showing note position.

FIG. 4E-3 shows the relationship between Euler's tone net torus and Pitch Value and musical key observed in the R² coordinate plane.

FIGS. 5A-5K are visual representations of the spectral theory of music.

FIG. 5A shows the vanishing point spectrum.

FIG. 5B shows the perspective projection spectrum.

FIG. 5C is an artist's visual representation of a fundamental projection matrix.

FIG. 5D is a graphical representation of adding the fundamental to the frequency domain using key function theorem.

FIG. 5E is an artist's graphic representation of an octave sub-filter.

FIG. 5F is an artist's graphic representation of the Zariski spectrum of guitar Theory G.

FIG. 5G is an artist's graphic representation of the Pierce spectrum of Guitar Theory G.

FIG. 5H is an artist's graphic representation of the Keimel spectrum of Guitar Theory G.

FIG. 5I is a representation of the Keimel Spectrum showing Favored Guitar Tunings OGDC=Open G Drop C Tuning (0 7 7 5 4 3); OGm=Open G Minor Tuning (0 5 7 5 3 4); OG=Open G Major Tuning (0 5 7 5 4 3); DG=Drop G Major Tuning (G6 Tuning) (0 5 7 5 4 5); ST=Standard Tuning (0 5 5 5 4 5); DD=Drop D Tuning (0 7 5 5 4 5); DDD=Double Drop D Tuning (0 7 5 5 4 3); OD=Open D Major Tuning (0 7 5 4 3 5); DADGAD=DADGAD or D Modal Tuning (0 7 5 5 2 5) and Open D Minor Tuning (0 7 5 3 4 5).

FIG. 5J is a visual representation of a system fundamental showing the 12 Overtones.

FIG. 5K is a visual representation of the diatonic chords of the K-Spectrum of the musical key product set.

FIG. 6 shows visual representations of music topology.

FIG. 6 First Row: Spherical Manifold, Hilbert Cube, Guitar Tuning Vector, Guitar Tuning Reduced to Canonic Point.

FIG. 6 Second Row: Triangle, Lattice, Arbitrary Non-Decomposable Rings, Partial Orders.

FIG. 6 Third Row: Sequence, Path, n-tuples, Real Closed Field Minus Finitely Many Points.

FIG. 6 Fourth Row: Spectrum, Trivial Topology of Musical Key. Musical Key Product Set Topology; Tuning Raises Set to Group/Intonation Reduces Group to Set.

FIG. 6 Fifth Row: Henkin Construction, Tablature Closed Algebraic Field (Chevalley Theorem), Nullstellensatz, Vanishing Field of Polynomials Over Guitar.

FIGS. 7A-7E are visual representations of Intersections and Unions.

FIG. 7A shows a sheaf of lines.

FIG. 7B shows a vanishing point.

FIG. 7C shows a sheaf of rings.

FIG. 7D is a representation of a Nullstellensatz.

FIG. 7E shows a binary tree.

FIG. 8 shows the Henkin construction Step 1: adding the system fundamental to the system to the frequency domain using orthonormal key function.

FIG. 9 shows Henkin construction Step 2: adding the orthonormal octave to the system fundamental.

FIG. 10 shows the product (sum) of the musical key topology and the guitar tuning is the open lattice of the musical key.

FIG. 11 is a graphic representation of out guitar music intelligence invention.

FIG. 12 is an artistic representation of a user constructing an open lattice of the musical key using Henkin algebra of meets and joins. (POSTER ARTWORK Adapted from Bernhard Geiger's “Adventures of Euclid in the World of Computer Vision” drawings in The Geometry of Multiple Images, Faugeras and Luong, MIT Press 2001, page 127).

FIG. 13 is a comparison of staff notation and tablature notation for the same measures of a written score of music showing the complexity of converting staff notation (at the top) into tablature notation (at the bottom), and visa-versa.

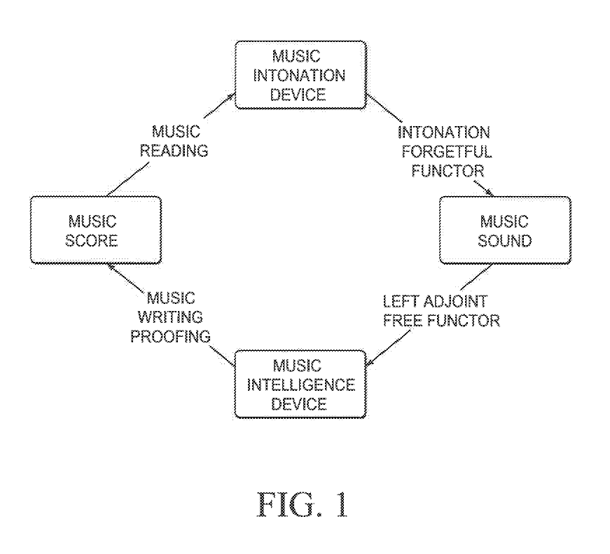

### DETAILED WRITTEN DESCRIPTION OF THE CURRENT EMBODIMENT

Our Tablature-proofing Turing machine is formally a seven-tuple T(G)=(S, t, b, M, d, G, Tab) where: 1) S is a finite set of string states of system; 2) t is a finite set of symbols that are index numbers in N (natural numbers) for pitch, string, and fret values; 3) b is the blank symbol in t; 4) M is the music data strip input; 5) d is left/right shift, 6) G is the initial guitar state of system; 7) Tab is a subset of S and is the output end state.

The instructions to the Turing machine is a five-tuple (current state, symbol read, [print symbol, erase, none], [left/right shift], new state).

The way that the Turing machine learns guitar music intelligence is by finding all the provable formulas in the Hilbert calculus (nullstellensatz) rather than using a choice machine where a human makes a choice or a pushdown automaton machine that acts as an algebraic “virtual tuner,” without second-order logic tables. Each proof in the Tablature is determined by a sequence of choices that are always between 0 and 1.

### Six Proofs of Our Tablature-Proofing Turing Machine.

The Baire Category Proof confers mathematic literacy on the guitarist, in the sense that the guitarist who understands the theorem can also find the forms of mathematics that apply uniquely in music. The mathematician who understands the Baire proof understands how guitar, and the musical key, is mathematical.

There exists a union of guitar strings that is open and closed, and therefore computable. When the guitar tuning is the union and intersection of open and closed strings, the guitar is in the tuned state of system defined by the condition that each Fᵢ in G is also in F₀. That is, the strings are open to a union with G because they are defined by F₀. Then, if each string in the union is closed, the union is also closed. The operations of intersection and union construct a lattice in R5. According to Zariski Topology Theory the lattice formed by the partitions in the guitar tuning union are predicted to have a non-trivial K spectrum 50 determined by the Z spectrum 40 that can be observed as spectral image projected onto R² using any adequate field of values.

The collection of prime ideals of the guitar tuning six-tuple G=(F₀, F₁, F₂, F₃, F₄, F₅), is called the guitar tuning vector algorithm G, where {Fᵢ}: f(x)=0 is in the form of an ABC triangle with the equational representation as a diaphanous first-order polynomial f(x)=a+b+c=0. Fᵢ, if I, is not equal to zero, are the secondary string fundamentals that defined by non-decomposable arbitrary rings. The ring cardinals are defined by pitch value tuning intervals between adjacent strings (P spectrum 30) or by the pitch value number of the open strings (“open” means not fretted). “Arbitrary” means the rings that define the rings can assume any value. “Non-decomposable” means rings are minimal on G. “Minimal” means there is no smaller partition than the tuning whose coverage is complete.

Baire Theorem sets forth that if the guitar strings are “in tune,” meaning the guitar strings are capable of forming a union, and are strings therefore observed to be open to union, it must be true that at least one string on guitar is everywhere dense and compact. (This is easy to prove for the first string, where the fret and pitch value index numbers are always equal, and therefore the pitch-position equivalence is a constant function.)

Then the proof checks to see if the strings are in fact topologically open. The definition of a tuning is each string fundamental is a simple product of the system fundamental that can be indexed with natural numbers. That is, each secondary fundamental is inside the system fundamental because the string is a computable instruction in G. The secondary fundamental is therefore an arbitrary prime ideal of the union of strings. G=(F₀, F₁, F₂, F₃, F₄, F₅) is a computable list of programmable instruction. Therefore, Tablature is a computable subset of G determined by adjoint matrix multiplication. The octave is the closure and the octave identity matrix is isomorphic to the guitar five-tuple that initializes T(G).

If it is true that each string is also closed by the octave interval identity metric, then it must also be true that the guitar is everywhere dense and compact, and therefore the guitar topology is completely decidable. The Baire Theorem says the closure is the intersection of the strings. The strings are independent and intersect with each other at the system fundamental at six right angles. Every inner vector product (sum) is zero. Each string is one unit in length (which is the condition of orthonormality in log space), and maps to the real closed field [0, 1].

The string is closed to all tonal movements by octave closure: No transposition can result in a value not on the string.

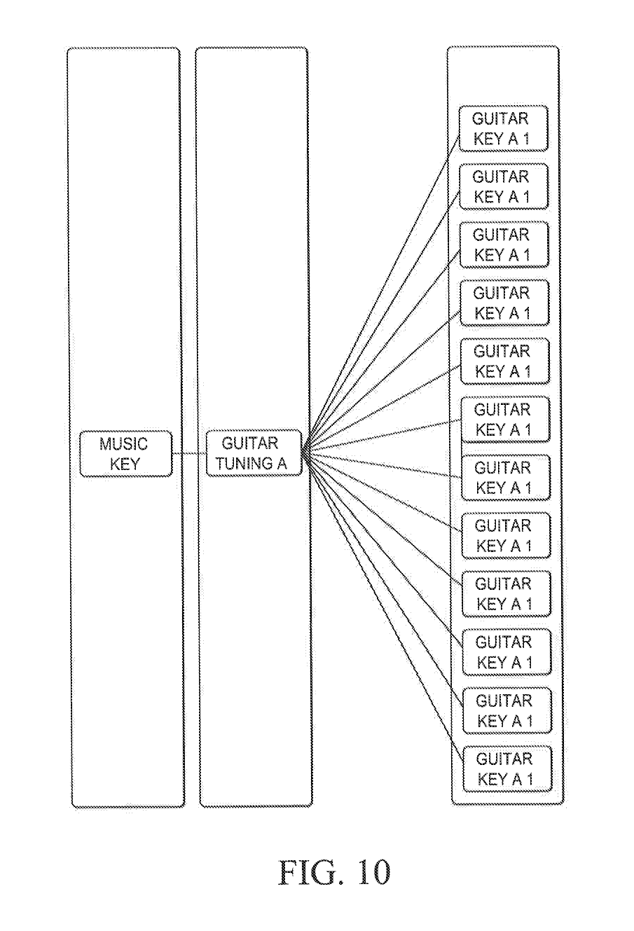

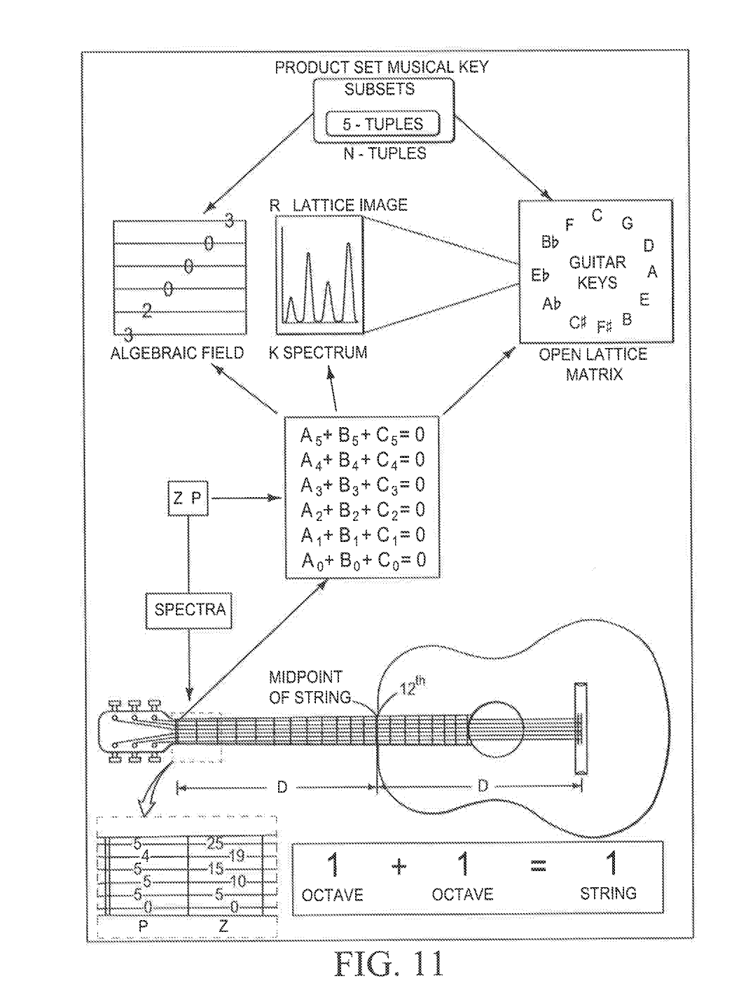

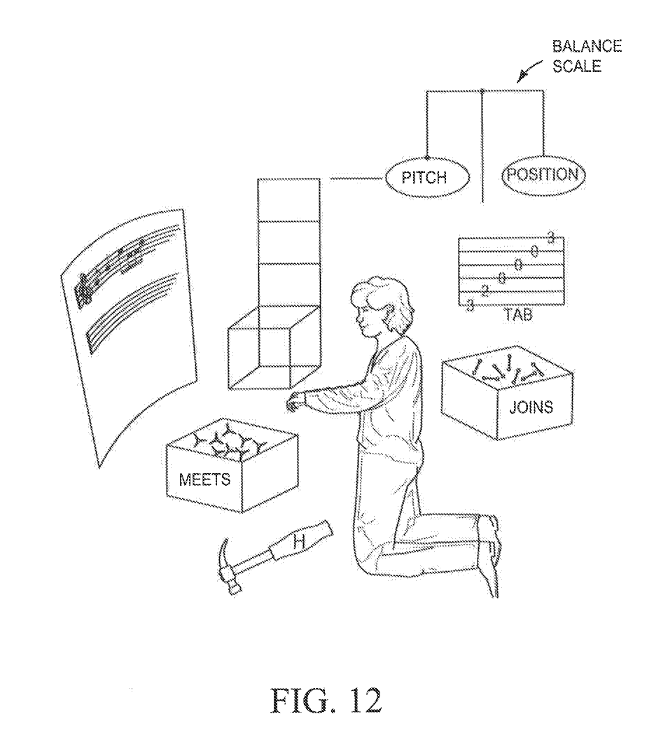

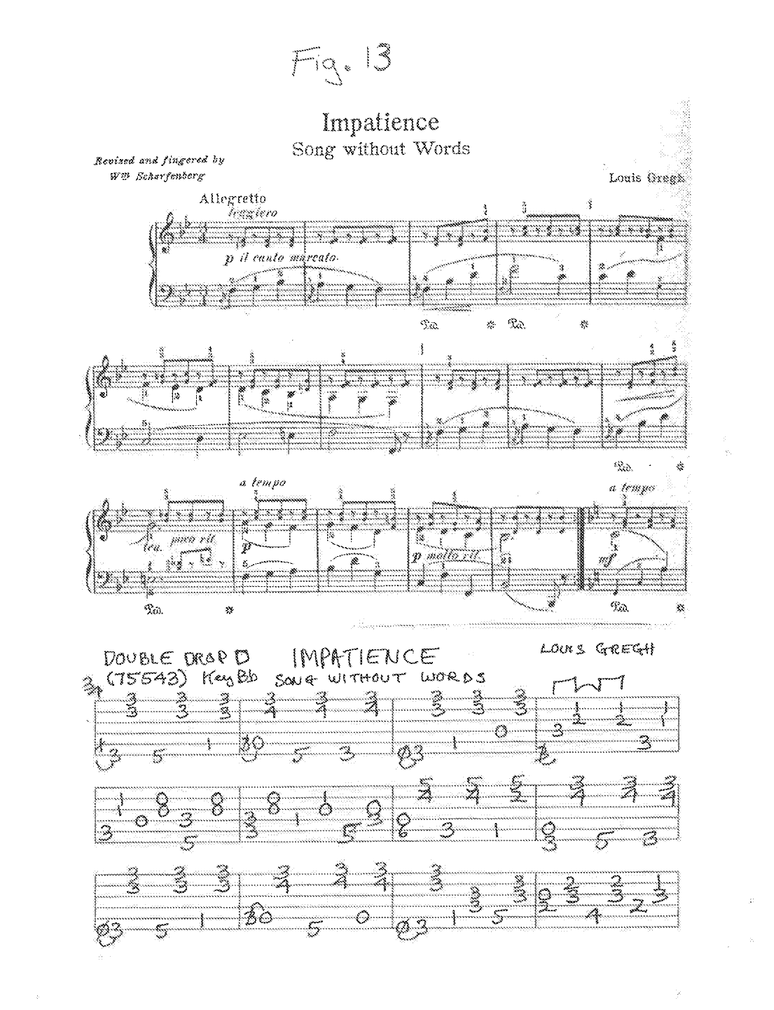

The Baire Proof perfectly mathematizes the guitar tuning model G as the union of six strings S in an O-minimal structure. The closure of G, denoted Cl (G), is the intersection of all closed sets that contain G (the guitar strings). The interior of G, denoted In (G), is the union of all the open sets that contain G (the guitar strings). The guitar lattice is defined by partial orders using intersection and union operations, which make a Heyting algebra of principle ideals. The product of the Guitar Tuning Vector G and the Musical Key Topology MKT defines the Open Lattice of the Musical Key, as shown in FIG. 10.

The closure of the guitar tuning is formally the algebraic closure operator of the nullstellensatz. The closure operator of the guitar must include the left adjoint free functor, and the formula for matrix multiplication that pulls back guitar intelligence.

The Baire proof implies that all one needs to know to learn guitar by computing Tablature is the guitar tuning itself and nothing else.

One can only learn guitar from the nullstellensatz (Principle of Projectile Invariance: The Tab only depends on the tuning).

The Baire proof of invention is elegant in brevity and so simple topologically, if perhaps not intuitively. The novel feature is the rather obvious observation that strings are open and closed, and everywhere compact and dense.

### Proof II: Octave Metric Space Existence Proof

The octave metric space proof shows how music topology is continuous at every point by showing the octave identity is the result of the convergence of two functions for pitch upon a single point, which is [1, 1]. The limit formed by the curve-lifting octave topology supplements the Baire metric proof by showing how closure has an identity matrix isomorphic to the product set of [0, 1]. A novel aspect of this second proof is defining the musical key topology as a metricized musical scale product set. The isomorphism of the product set of [0, 1] and the musical scale on [0, 1] establishes an algebraic equivalence between the clopen sets of prime ideals and the clopen set of principle ideas. This concept establishes connectivity between guitar tuning and musical key.

The product set of the musical key has a metric space equivalent to the product set of [0, 1], which is log space. Therefore music is an L-language.

1) Let S₁₂=1 be a twelve-tone sequence in an octave metric space. Then the sequence converges on at most one point as a limit, which is [1, 1]. Alternately let S be a guitar string formed by the union and intersection of {frets} and {pitch values} given by the pitch-position equivalence PV # frets defined by placing fret twelve at the exact mid-point of the musical string.

2) If we assume the metric of the space is [pitch value, music key], then there is immediately a contradiction because if [0, 1] and [1, 0] are independent generators of music, then the music system has two fundamentals, which is impossible. The fundamental is defined as the lowest mode, so none can be lower. Also, because of the greatest lower boundary defined by the fundamental, if x is a fundamental and y is a fundamental, then x=y. Therefore, one must conclude that [1, 1], [0, 1] and [1, 0] are Boolean equivalent idempotents E(A) (Identity of Boolean algebra).

3) To prove the octave additive and multiplicative identity, and the compliment of the octave point, which is the octave filter, make a clopen set on which all other clopen sets are based, the octave point is defined as a precise point shaved off a unit interval using the curve-lifting topology defined by the convergence of a binary function on [1, 0]:

lim_{X→n} q:p=f→p=log₂ f such that f(q)=p is everywhere continuous on X. (X is the curve-lifting topology). When the music topology is a metric space topology then every subset is also metric and therefore decidable.

The above map makes music topology continuous at every point p in the frequency domain. The map proves the number of points in the line and the exponential functions are exactly the same. The curve and the line match up point for point as exactly as if we had counted each point. That means the curve can be triangulated as if it were a straight line, vector, point, triangle, square, Hilbert Cube or Sphere.

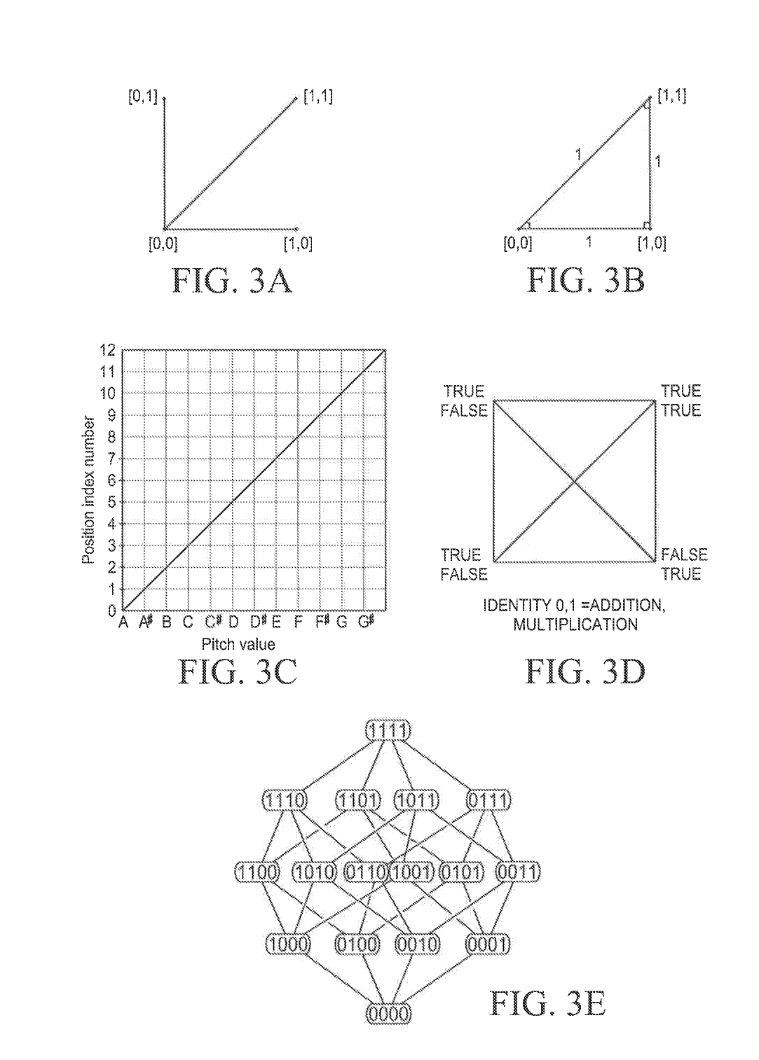

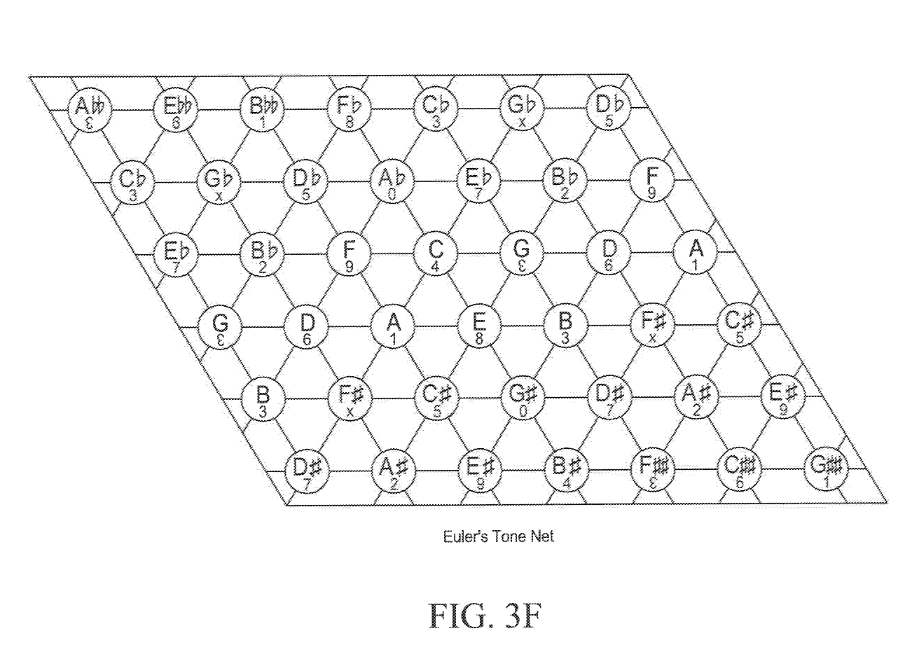

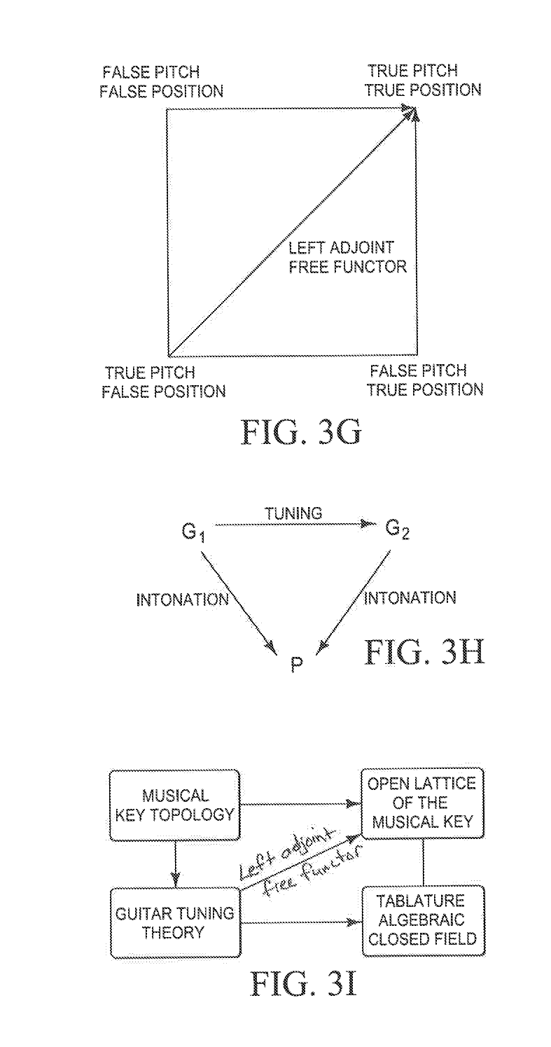

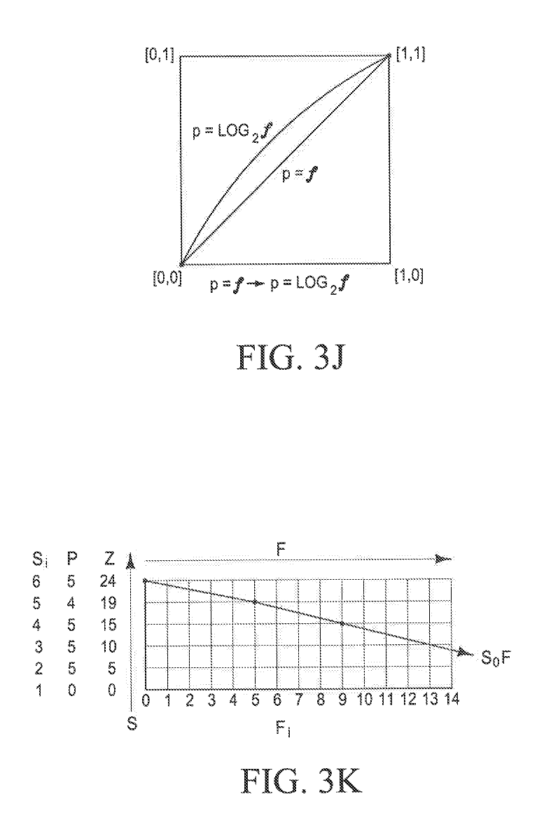

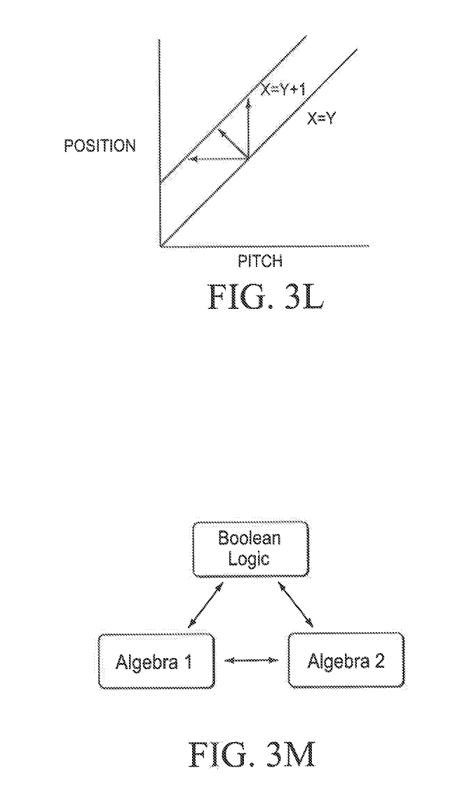

The curve-lifting topology (FIG. 3J) matches the curve and line match point for point. This means the metric space is decidable, as if the octave identity and filter (sub-filter as well) mark the R² coordinate plane off like a piece of graph paper that can now be used for the spectroscopic and graphologic inventions.

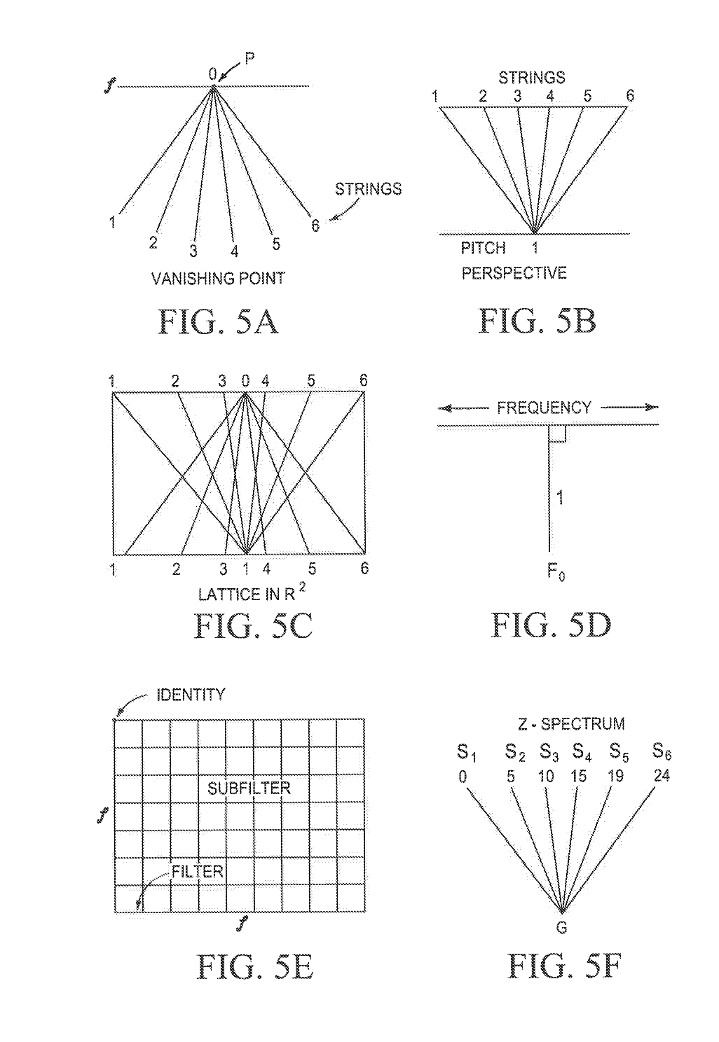

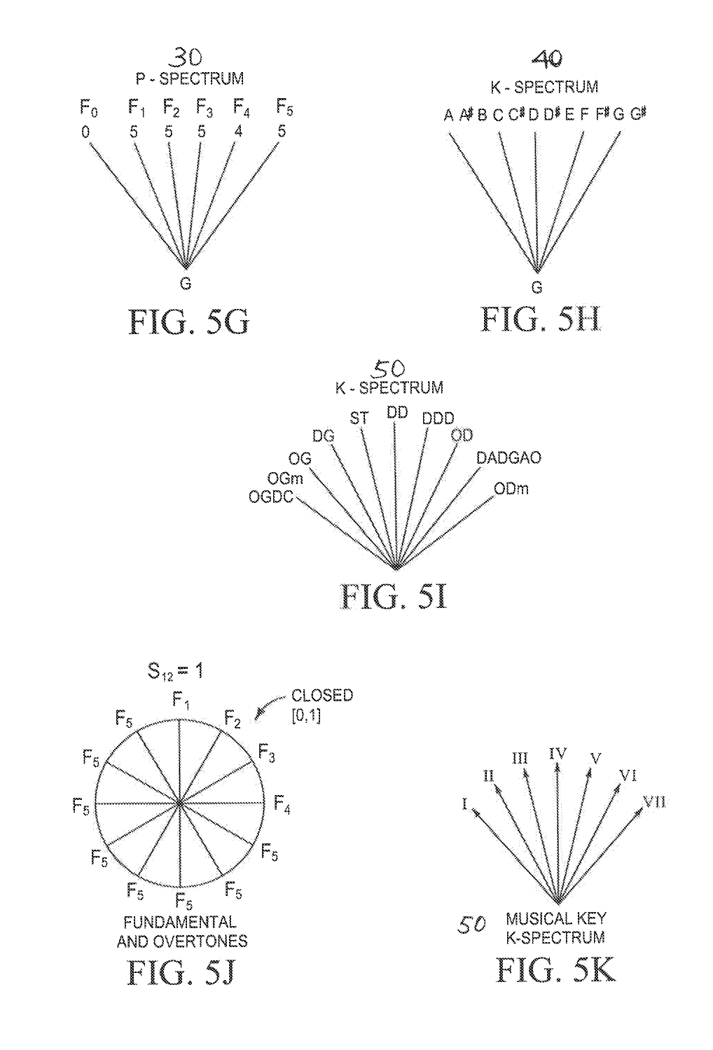

Applying the Cauchy theorem the metric proof predicts that graphs and spectrums of music are useful diagrams even if they cannot be accurately drawn on paper without using a projection. (FIG. 5E Octave Sub Filter.)

The curve-lifting topology is the metric that underlies the open and closed union and intersection of strings in Baire Theorem. The metric proof restates the Baire Proof, that music theory is everywhere compact and dense: the octave makes [0, 1], [1, 0], and [1, 1] equivalent orthonormal axes. Therefore the identity matrix of the octave is the product set of [0, 1], which is log space.

The difference between the minimal and maximal expression of music is the difference between the trivial topology of the musical key, defined as {S₁₂,Ø} and the product set topology P(S)=Πᵢ₌₀ⁿS₁₂. The product set topology is the family of all open subsets of the musical key that do not contain the musical key itself.

(Note: The terms “product set of the musical scale,” “product set of the musical,” and “musical key topology” are used interchangeably herein (and inexactly), but this should not cause confusion.)

The guitar is an open subset of the musical key product set because the product set is all the n-tuples that are possible and the guitar is in the five-tuple subset of tuples. The guitar tuning is therefore original to the musical key because it does not depend on the musical key topology but only depends on tuning.

The metric proof is far reaching because, if the music topology is metricized by the octave identity matrix, then the entire product set of the musical scale is decidable and each tuple can be computed because each tuple initializes its own Turing proofing machine according to the prime ideals of the n-tuple vector coordinates in the Zariski Topology of Guitar, which has coordinates that are same as the prime ideals. The prime ideals are the same as the decoder ring numbers that the nullstellensatz “zeros-out” on in the Z and P spectrums.

It is known the octave metric is a metric unit in music, but prior to our invention it was not recognized that the octave is the origin of algebraic closure, or that the octave is surgically precise to a point (exact a multiple of 2) as a continuous limit. In particular, if the endpoints of S₁₂=1 in [0, 1] are precise, then so are the notes. The scale is continuous on [0, 1] in the real closed field minus finitely many points—the definition of a semi-algebraic set.

What is particularly novel, useful, and original in the metric existence proof is the observation that pitch is a binary function that defines the binary path of tone movement as being three-fold and NOT two-fold as commonly thought. (See FIG. 3O).

By itself the octave metric proof is a proof Tablature is computable because the octave identity proves the binary path of tonal movement is decidable. If tonal movement did not have three degrees of freedom, then the proof would show a machine that constructs and proofs L-sentences in Tablature does not exist.

A three-fold path means tonality is a structure in three-dimensions, not a curve or a surface. To understand a 3-D structure, as Mobius noted almost two centuries ago, requires a fourth dimensional space.

When the product set of the musical key is metricized, something quite profound results: a nontrivial equivalence between: 1) the algebra of the clopen sets of the prime ideals of the n-tuples (the subsets of the scale product sets); and 2) the algebra of the clopen sets of the principle ideals, the Boolean ring. This non-trivial equivalence relation is well-known in mathematics but has not been previously applied to music.

The metric proof is equivalent to the Baire Proof because the proof lies in the union and intersection of sets that are both open and closed, so the coverage over the range elements of the model is complete and everywhere dense and compact (translation: guitar computations make ordinary common sense). Quantitation over the elements of the guitar means that every value is known by the guitar index numbers for pitch values, frets, and strings. Those are the two-countable guitar model elements which have sophisticated second-order logic that is the sum of the first-order model logic and the commutative lattice of generalized transposition. This restates the pitch-position equivalence E PV#FV as prime ideals#principle ideals, which are the elements of Tablature algebra.

The octave metric proof leads to the understanding that music tonality lies somewhere between the minimal expression and the maximal expression. The minimal expression musical key is useful as a learning aid while the maximal expression of music tonality far too complex to be generally useful. The idea that useful tonal expression lays very specifically in certain “golden” tuples that have a high probability of use explains how the trivial universal musical key can have a grand expression that wildly exceeds expectations based on the simple twelve-tone set. The idea of special tonality requiring special learning also explains how it is that guitar intelligence is a higher-dimensional intelligence that has remained a secret code for centuries.

The minimal expression of music is the universal musical key (the set-of-all-sets) that is the same in polyphonic music for every instrument regardless of how the instrument is configured, tuned, and intonated in R³.

The difference between the minimal and maximal expression of music is the difference between: 1) the trivial topology of the musical key, defined as {S₁₂,Ø}, and the musical key product set topology, P(S)=Πᵢ₌₀ⁿS₁₂. The product set topology is the family of all open subsets of the musical key that are disconnected from the musical key by the vanishing polynomials in the nullstellensatz equations.

The family of subsets of the musical key product set topology are original, but most are not useful because they do not appear in a K spectrum 50 (and therefore have no great probability of use).

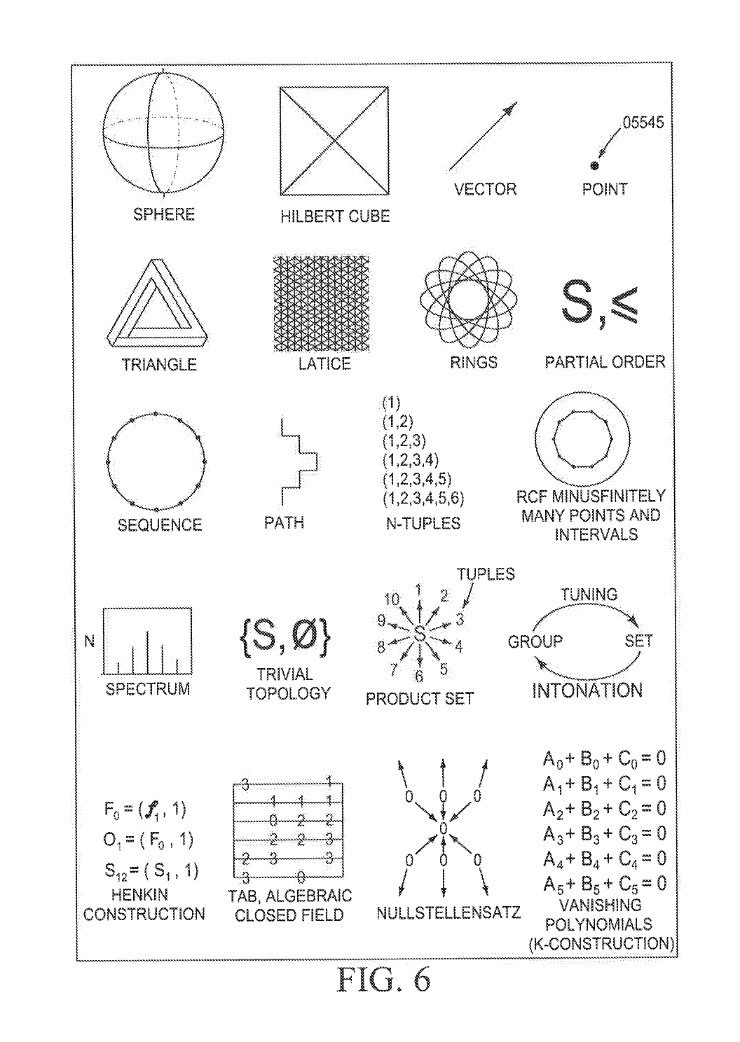

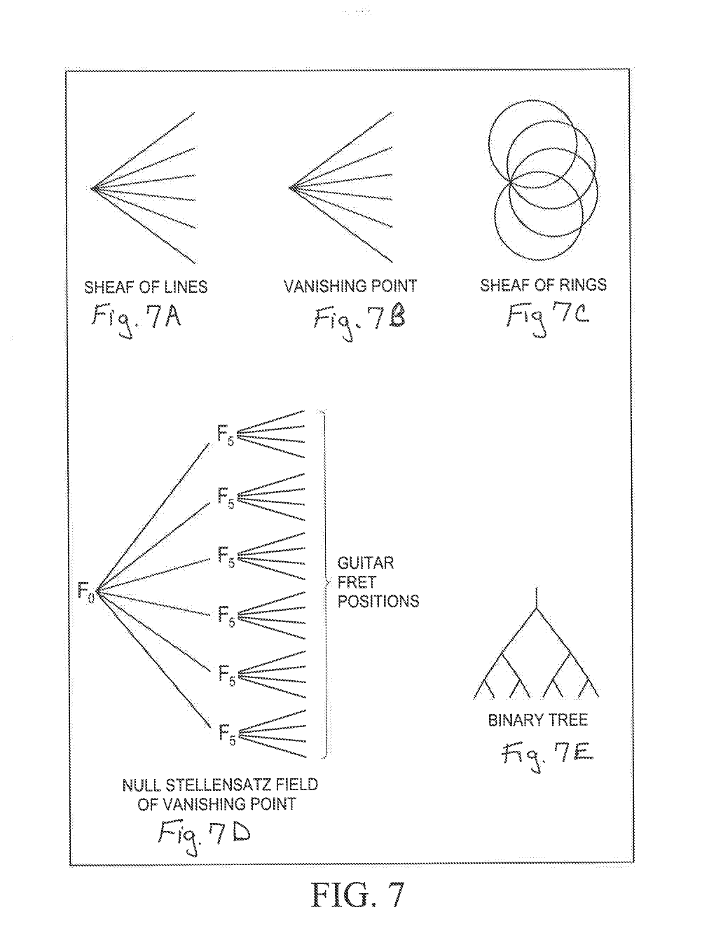

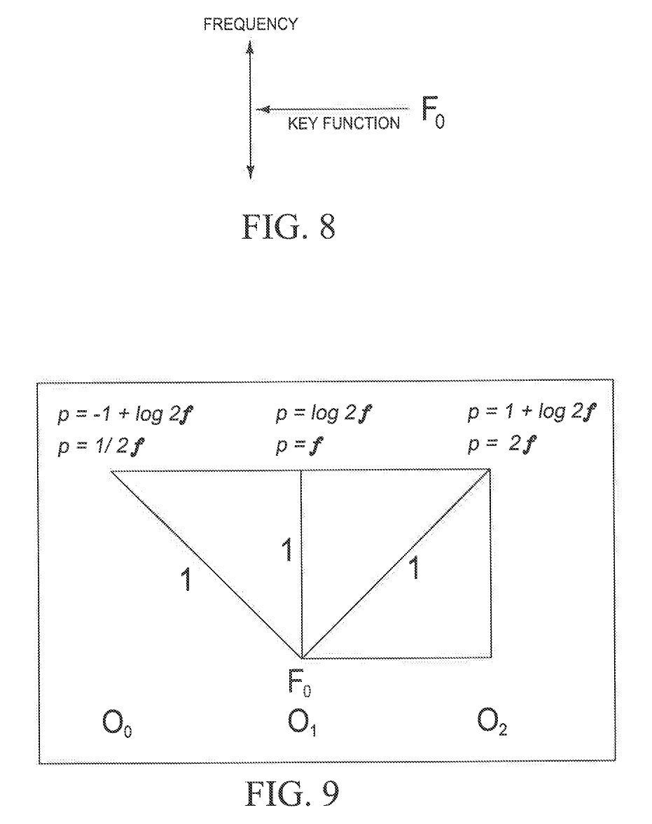

The fact that guitar tuning five-tuples are “subsets of the musical key that do not contain the musical key itself” is an example of the type of fact that makes perfect sense internal to the guitar (over the elements of guitar). Learning the Key of C on a musical instrument does not equal learning the Key of C on guitar, where every Key of C is different and must be re-learned whenever the guitar tuning changes by the smallest increment. The universal musical Key of C is a strongly minimal tonal expression that is SET, while the guitar key, the key inside the guitar, is GROUP. GROUP is richer intelligence than SET. Going from GROUP to SET by intonation is easy; going from SET to GROUP by tuning is difficult, and requires a left adjoint free functor vector. (See FIG. 6).

In the metric space proof, if the topologic space of the twelve-tone sequence is once metricized, then the metric and the identity and the filter extend to every possible subset in Rⁿ. This means that our Turing machine uses a real closed field minus finitely many points for constructing and proofing L-sentences.

The metric space proof of existence is useful for defining the path of tonal movement. In the R² coordinate plane every path of tonal movement is equivalent and the binary path of tonal movement is perceived to be two-fold (two-countable) because a note can only move by pitch and independently by position. However, this is an illusion.

The metric space of music topology is a space where every distance is 1 or 0. Theory predicts that the Boolean ring and its graph will be found in every possible musical graph, and this theoretical prediction is confirmed by music graphology.

### Proof II: First-Order Model Theory Proof

The internal algebraic language of guitar L={E} is proof of guitar tuning theory G, or, just tablature by itself. Tablature is proof of a Turing machine because Tabs are collections of L-sentences that are proof of guitar tuning G.

One can define the guitar tuning as a five-tuple: G=(F₀, F₁, F₂, F₃, F₄, F₅) where Fᵢ are non-decomposable arbitrary rings defined by pitch value tuning intervals between adjacent strings (typically in the range of two to seven). When every Fᵢ is a product (or sum) of the system fundamental, the guitar is “in tune.” Since G is a finite list of computable instructions that zero-out on F₀, the tuning is a nullstellensatz and the Turing apparatus must halt.

### Proof IV: Music Spectroscopy Proof of Existence

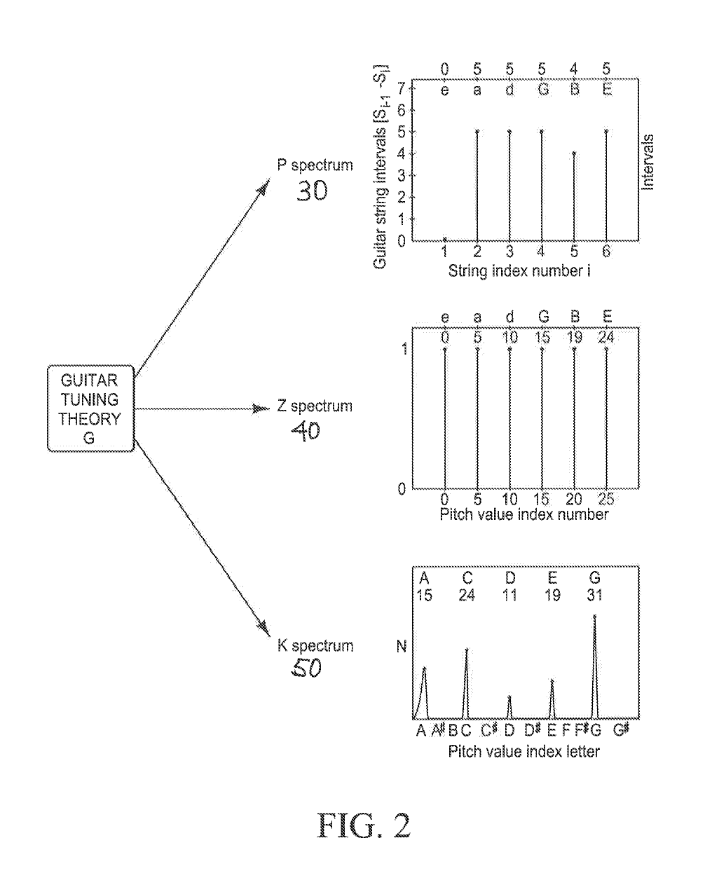

Music spectroscopy is also a proof because the Baire Category Theorem predicts that the guitar tunings have P 30, Z 40, and K 50 Spectra that can be observed as graphs in R². (See FIG. 2). The steps are as follows:

1) Define the P spectrum 30: the prime ideals of the guitar tuning (such as (0 5 5 5 4 5)).

2) Define the Z spectrum 40: summation of the P spectrum 30 (for example (0 5 10 15 19 24))

3) Define the K spectrum 50 for any set of intonation values as the probability of usage of each element in the set in any field of observed or calculated values. The K spectrum 50 is created by directly counting finite sets. (a halting apparatus).

In guitar spectral images the P 30 and Z 40 spectra are ordinarily only observable by seeing or touching the guitar and are not available to auditory reckoning. However, anyone can observe the K spectrum 50 without special learning, at any time for any purpose.

When the P 30 and Z 40 spectral GROUPS (polynomial, identity, inverse) are intonated at E2, observation in any field of intonation values will predictably show that the K spectrum 50 vector set for the most probable (or favored) guitar keys will always be (G C E A D F), and that the use of the remaining six guitar keys will be negligible.

In turn, in any arbitrary collection of music, the spectrum (G C E A D F) is a reliable guitar key signature fingerprint K spectrum 50 indexing the guitar tuning source. Therefore the K spectrum 50, K of G, written K(G), is proof of G. That is, (G C E A D F) is literally a fact in G that is proof of (0 5 5 5 4 5)/(0 5 10 15 19 24) guitar tuning intonated at E2. The K spectrum 50 is invariant under the law of large numbers. K is by definition, a non-trivial order: that proves that G is two-countable (has two disjoint index sets) and that proves that invention T(G) is decidable.

Guitar music has a spectrum like light, only appearing in a graph as finitely many points on a unit interval under an octave metric. Light is chromatic like music but has no octave.

The example of K spectrum 50 used most often is the spectrum of musical key probability, but every possible subset in the musical key product set (notes, intervals, chords, scales, modes, keys, tunings, paths, rings, loops, lattices, partial orders, sets, groups, and so on) has its own unique spectral graph that can always be recorded by counting finitely many things. (See FIG. 5).

Observation of the K spectrum 50 is highly significant intelligence because a graph of the spectrum is an actual image of the open lattice of the musical key topology in R² that directly confirms predictions in the nullstellensatz that there is a non-trivial equivalence relation between pitch and key. The K spectrum 50 is an anomaly in Affine theory, which predicts guitar intelligence cannot be recovered after intonation.

The K spectrum 50 is “left adjoint,” meaning the inductive facts, once proven can easily be inverted to prove other facts: First, the Z 40 or P 30 spectrum is used to learn the K spectrum 50; then, the K spectrum 50 can be used to recover the Z 40 and P 30 spectrum. This shows the power of our Tablature-proofing Turing Machine operation: Once the K spectrum 50 is learned by counting, it does not have to be re-learned every time the tuning is encountered. That is to say, when the K spectrum 50 is learned, one doesn't have to keep learning the K spectrum 50 each time because its existence has been proven previously by the proofing apparatus. The invention T(G), whose output is always the best tablature data.

The number of five-tuples in guitar tuning space is very large, but the K spectrum 50 of golden tunings is limited to something on the order of ten to at most one-hundred tunings, and judging by popular use, most examples of the guitar nullstellensatz are useless. Knowing which n-tuples and which rings are useful and expressive is important intelligence that can be learned by K spectrology in music.

The K spectrum 50 for any set is almost constant, but as the musician becomes more experienced, the number of keys and tunings in use tends to increase. Otherwise, the K spectrum 50 is the same for every musician, style, era, locale, and so on. Only the n-tuple and it polynomials determines the tonal expression.

Proof V: Music Graph Theory

The principle of monotonicity states tone movement can only be strictly increasing, strictly decreasing, or constant. Monotonicity is the connection between music algebra and music geometry that triangulates graphology.

FIGS. 3A-C show the characteristic pitch-position graph is a multigraph in which there are three equivalent directions with a common metric and at least 1 other point in common besides the point of origin (the octave). The edges of the graph are interchangeable and the graph always appears to be the graph x=y.

According to the monotonicity principle, the graph cannot rotate, the inner product or sum that results by combining any two vectors is zero, and every value in the graph is barycentric (right upper quadrant).

In the graph, the absolute value topology (using the Pythagorean distance formula) and the product set topology (using the product set of [0, 1] are equivalent because the equation for the triangle a²+b²+c²=0 is the same as the equation a+b+c=0 because every a²=a. The reason these equations are the same is that in log space every a=0 or 1.

The absolute value topology in music must, however, be rejected because it is not valid to arbitrarily partition the real number field into subsets that are not integral domains. For example, the set {0, 1} can be reduced to the union of the disjoint open sets {0} and {1}, but the real numbers cannot be reduced to the union of two disjoint sets.

Our music spectrogram and music graph inventions both use the R² coordinate plane to depict music intelligence, but the spectrogram is a frequency domain histogram while the graph is a diagram of log space, like a Hasse Diagram of a partially-ordered set or a logic circuit diagram.

Log space is the metric space in which the tonal expression of algebraic languages in music are defined. L-sentence tonality is connected in log space. Tonality, short for tonal expression, here means the sum total expression of every possible L-element, L-relation, and L-function in a system defined by the L-signature of the language. This definition for tonal expressivity as a sum total corresponds to the definition of expressivity as applied to an algorithm as well as a software program. Expressivity on guitar is therefore programmable by the L-signature defining the L-language.

There are two equivalent ways to understand tonality in music using graphs: 1) Musical Key, and 2) Path of Tonal Movement. In Affine theory, every Key and every Path is equivalent but in fact both Key and Path emit a strong K spectrum 50 that proves that not all Keys and Paths are true in the language truth structure. The perception that music is defined in a plane creates the illusion that all music intelligence reduces to mere points and intervals on a line with no dimensionality. In R² all paths of tonal movement are equivalent, but this is not the case for guitar.

Our invention, that musical graphs are defined in log space, means that graph theory in mathematics can be directly applied to learning guitar. Concepts of path, tree, intersection, connectivity, distance, eccentricity, degree, sentence, truth structure, and so on, which apply in music model and graph theory, have numerous applications in music.

Eccentricity in graph theory can be used to find the best position for a note on a guitar in the same way that graph theory is used to find the best location for emergency service, a problem solved by reducing the number of eccentric paths to the smallest degree possible. In the same way, the guitarist wants to find a path for tone movement on guitar that has the least amount of unnecessary travel because then notes can be played faster and more expressively.

The guitarist is interested in finding the sequence positions for pitches in the guitar fret board matrix that construct the optimal isotonic path of tonal movement. The goal of K-weighted guitar graphs is to find faster and better paths of tonal movement by truth structure induction. This means that the guitar is learned proofing one fact at a time until all the countable sentences possible in music are inductively proofed using the signature. This optimizes the function of T(G) to the maximum.

One attempt to verbally explain L-facts in the guitar language truth structure external to guitar might sound something like this: Sometimes the guitarist wants to match open string notes (unfretted notes). Other times, the guitarist wants to move the guitar music to work at a new location (commute) and needs to draw the old guitar tablature frames in the new perspective field of view defined by a different choice of tuning signature.

Each set of equivalent paths (isotonic paths make isotonic sentences which are permutations of pitch isomeric structures) has its own K spectrum path intelligence, a computable fact that attaches a true or false value to each path that can be derived by inductive proof from the L-signature. K spectrum 50 coordinates are a collection of L-facts (or K-facts) that have already been proven, observed, or recorded.

The path of tonal movement on the guitar is critical because not all paths are equivalent. The primacy of correct paths in connecting structures has a curious implication because it is one of those facts, internal to guitar, that does not make sense external to guitar: One might believe the same sequence of notes will always be the same expression regardless of the language signature, but this is not true.

When the guitarist plays the same notes, the path the notes follow on guitar affects how the notes sound as much or more than the pitch. What good are beautiful notes that cannot be played articulately? What is curious is that the auditory observer expects the same pitch values to sound the same regardless of the guitar tuning and the observer persists in thinking the guitar tuning is not important music intelligence even though the K spectrum 50 informs, according to popular usage, that most guitar tunings are useless.

The K spectrum 50 of “golden guitar tunings,” which can be discovered only by induction using the tuning tuples and nothing else, is anomalous to the common perception that if all guitars have the same range of notes and the same pitch value set, then all the guitar tunings and all guitar keys sound the same, and are at most trivially different by intonation.

Topologically each guitar tuning space is an extremely disconnected space so that finding the path that connects one guitar tuning to another is not easy. This is because any incremental change in tuning requires completely re-learning how to compute the tablature.

In other words, facts about tuning G mean nothing about guitar tunings H, I, J, or K. Each tuning must be learned separately as a system of proofs yet no re-learning is required when the guitar intonation changes, which confound the auditory observer.

To illustrate this principle, observe that when the capo on guitar is raised to a higher position on the guitar neck, the shorter string length causes the guitar intonation level to increase but since each string is shortened by an equal distance, the guitar tuning does not change. This proves that intonation and tuning are independent directions of movement.

On the other hand, the guitarist can learn to hold the observed musical key at a constant pitch while the capo forces the guitar intonation pitch up by transposing the guitar key down a step for each step up in capo position. This is a difficult transposition problem for the guitarist to solve, however, since each guitar key must be individually proofed for correct form. Guitar key approaches the impossible if the capo steps are chromatic because that would force the guitar musician to use guitar keys that do not appear in the K spectrum 50. Guitar keys that do not appear in the K spectrum 50 are generally too difficult to be useful because they are more difficult to learn and too hard to play. In practice, the guitarist forced to follow a chromatic path of guitar key changes will always use the K spectrum keys, and simply shifts one of the K spectrum keys up or down the neck to make the unfavored key. In this way, the musical keys that are not in the K spectrum 50 are in fact keys that are not in the particular L-language according to its guitar key signature.

Without the nullstellensatz to navigate tuning space, the guitarist is hopelessly lost in five or six abstract dimensions, although internal to guitar everything makes sense but the operator still may not believe this is true, or understand how to construct L-sentences in general as proofs.

With the guitar nullstellensatz, the guitarist knows exactly how to proceed step-by-step to reconnoiter, how to optimize each path of notes beginning in an illiterate state, knowing only the tuning signature and nothing else about how to make the graphs.

Graph theory provides a logic system for constructing L-sentences in Tablature that are correct proofs, but it is the probability functions in the K spectrum 50 that make the graphs weighted in such a way that all paths are not equal which creates the sense of order and meaning that make L-syntax and L-semantics. L-syntax is the sequence of positions and L-semantics is the true or false value attached to each position value and sequence. The true or false values are learned from the K spectrum 50.

The K spectrum 50 is comparable to a second system of colors in addition to the chromatic ordinal colors. In the chromatic order, the colors are indexed by natural numbers, but in the K spectrum 50, the colors are index by a magnitude, which means the harmonic values in the K spectrum 50 are cardinal not ordinal intelligence. Music is a marriage of chromatic and harmonic K functions.

The guitar musician will find that our Tablature-proofing apparatus optimizes guitar music arbitrarily close to perfect, because the musician will notice that, when a new and improved solution is learned, the solution spreads to all other Tabs, even in other tunings. The proofing of Tabs also continues whenever the Tablature is played on guitar, because playing the Tabs is like a person who goes from room to room writing, erasing, or sounding notes in the Tablature memory cells until the last error is corrected and the machine halts.

A limitation on the process is the machine only knows which of two solutions is best, and not when the absolute best solution is discovered.

The following example may serve to illustrate how music graphing is a practical apparatus: Sometimes a change in tuning forces the guitarist to find a new path for notes because some kind of gap or overlap in the union of strings is not pleasing. That is to say, five is the favored tuning interval given the guitar scale. Tuning intervals that deviate from the favored five steps create logistical problem which are usually related to increased numbers of isotonic tone paths (for tuning intervals less than five steps) or increasingly eccentric tone paths (greater than five steps).

When the solution to a path sequencing problem is found, the solution may also apply in the old tuning, sometimes even without modification, but the novel path could not be learned in the old tuning because there seemed no need, when in fact the second path is more like a master level object than a useless object-something useful that only takes a little more skill to use, but has a big effect on expressivity and originality of guitar.

Changing tuning and key, and particularly going between favored tunings and keys repetitively hones guitar intelligence by “weeding out” the bad Tabs and emphasizing good Tab by optimization, and by understanding how it is that different guitar tunings are different languages with difference uses in music composition.

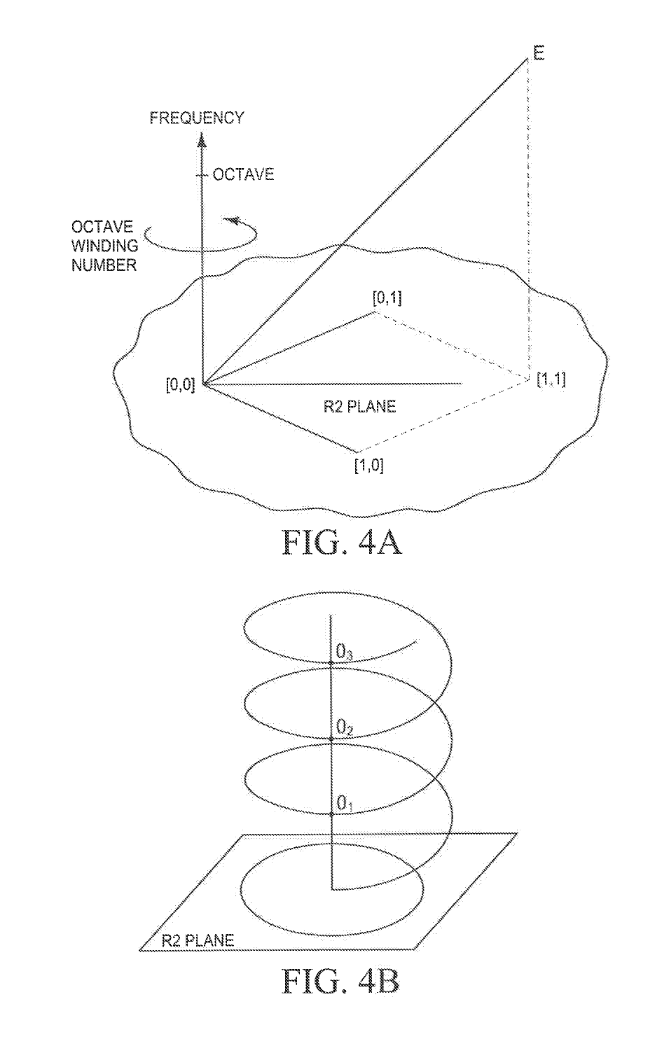

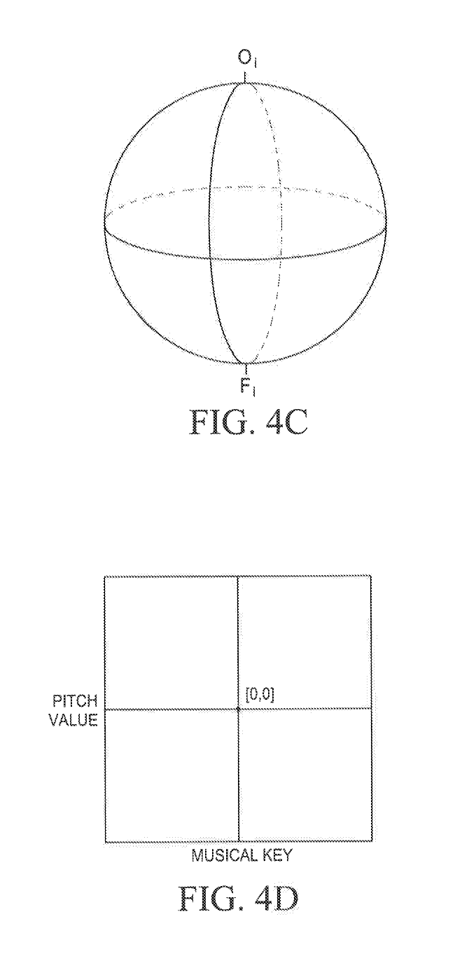

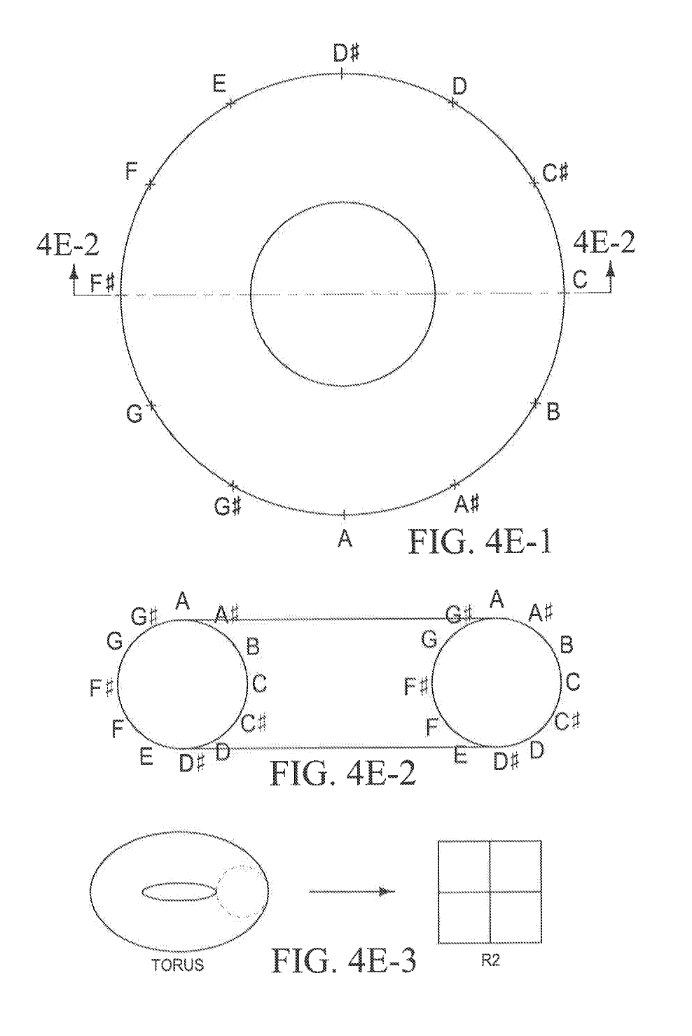

Every path is equivalent in the R² coordinate plane, because in a rectangular grid every path between two points has the same distance metric. According to the Affine law of similarity in a plane, there is no transposition of the musical key in a plane. (See FIG. 4).

The perception that learning a new musical key is trivial is contradicted by the guitar key that must be individually re-learned for each guitar key signature.

FIGS. 3A-3M (MUSIC GRAPH THEORY) show graphs of pitch-position equivalence relations. Each graph shows pitch-position equivalence does not lie in the plane of observation. No music graph can be drawn correctly on paper but every graph will always be orthonormal. Orthonormal means there are three directions with the same metric unit. The appearances of such graphs is misleading: The graph always seems to be the function x=y, but that is not true. The graph is x=y and also the x and y axes that are equivalent. The line x=y is the projection of the pitch-position equivalence onto the plane of the graph. See FIG. 4A which shows Pitch-Position Equivalence E in R³ Projected on R². FIGS. 4A-4E3 illustrate how the pitch-position graph is defined in three dimensions and projected onto a plane. See FIG. 4B Octave Winding Numbers, see also FIG. 4D Pitch Value and Musical Key Observed in R² Coordinate Plane and see FIG. 4E Euler's Tone Net Torus.

It is theoretically predicted by the monotonicity principle that intonation values have a spherical fundamental group with SO3 because every harmonic object can have at most one fundamental. See FIG. 4C Spherical Manifold. Again, as in the octave metric proof, the Law of One Fundamental (Greatest Lower Boundary principle) proves [1, 0] and [0, 1] cannot be independent x and y generators of the pitch-position graphs. Instead, it must be true that [0, 0], [1, 0], [0, 1], and [1, 1] are idempotent equivalents because they are the first product set of a Boolean ring.

The geometric diagram of the most elemental triangle ABC and its equational representation a+b+c=0 is demonstrated deductively by graph analysis in every possible pitch-position graph, and theoretically it can only be such a multigraph, according to the Stone Representation Theorem.

The Stone Representation Theorem implies that all tuples music have a natural representation. The graph theory proof of computable Tablature establishes both a theoretical and an experimental proof according to the [0, 1] Law of Graphs: Guitar theory predicts the diagram and the diagram is experimental proof of the guitar theory.

The observation that the inner product in music graphs is always zero leads to a proof that Tablature is computable because the triangle is orthonormal, and therefore constructed in log space. The music multigraph graph shows primary harmonic elements in music, in any intonation field are always isomorphic to semi-algebraic triangles.

It is important to note that tone is defined by intonation. “Note” is a different way to spell tone, and the meaning of the word note is not precise. In casual use, the word note tends to be reserved to designate the pitch value of the note. In fact every note has both a pitch value and a position, which have a uniquely non-trivial equivalence relation.

We observe music is semi-algebraic because music is the finite union of notes and intervals in an octave unit, where whatever is true for notes is also true for intervals, and vice versa. This defines a special category of natural graphs that are aesthetically pleasing because no two graph edges meet other that at the octave, all distances are 1, and all angles are right angles. So the topologic space of the graph is metric and the graph cycles and bonds (cuts) are interchangeable.

For example, the circle of 5ths graph is equivalently a K12 cycle or twelve-pointed star, but in either case the graph is not actually in the plane of the drawing. The circle is a useful geometric representation with a natural equation for the path that results from quantifier elimination and octave closure. (K12 is a twelve-cycle graph in graph terminology not related to K spectrum of K12).

Music graphs belong to a category of graphs, three-fold graphs, that can be drawn in essentially only one way. Musical graphs are all isomorphic to the elemental Boolean atom in music theory. Musical graphs have utility and similarity that is mathematically defined.

The non-planarity of the pitch-position graph is geometric evidence of non-triviality that is critical to guitar intelligence. Non-planarity of music graphs is not recognized in the literature of music. The non-planarity has always been evident and observable, but without the commutative lattice, and the generalized theory of vanishing transposition, using the vanishing nullstellensatz, no one had any reason to verify if the pitch-position graph is or is not in the plane of the graph paper.

Even Euler, in 1739, was fooled by the illusion music is defined in R², as opposed to projected onto a plane of observation. A plane of observation in music is the same thing as the horizon, which is the line at infinity where parallel lines meet. In the plane where music is observed, all of the arrows connecting guitar to music meet at the limit value of pitch.

The tone net shown in FIG. 3F is a useful geometric diagram with a natural equation, but the figure is not accurately drawn: Every angle should be 90 degrees, not 60. Triangles with three right angles are equivalent to a geometry where parallel lines meet. Triangles on the earth surface, for example, may have three right angles (SO3 symmetry).

The fallacy that music topology is planar, which never made sense has persisted for nearly 300 years. Log space in music was not recognized and log space L-languages and L-sentences on guitar and in music made no sense to anyone but the guitarist. There seems no way to learn guitar by ear, only by direct observation or instruction. The problem is not solved by a machine that transcribes pitch accurately. The demonstration of log space in graphs is therefore an existence proof of computable L-sentences in L-tablature.

Our invention of musical graph theory that follows the Baire Category Proof of Lattice existence, is supplementary to music spectrology, a similar off-shoot, because both spectrograms and pitch-position graphs concern images in the R² coordinate plane, viewed in different graphs. Importantly, the K spectrum makes a musical graph into a probability weighted graph.

A K-spectrum weighted graph may be used to rank a sheaf of isotonic tonal paths in order to calculate which path is the least eccentric. This method amounts to finding better, faster way to play guitar mathematically.

The case of twelve-tone music illustrates the weighted graph usage. In twelve-tone music, the composition rule is the condition the path of tone movement must pass through all twelve tones without repeating the same tone. Therefore, the probability of using each tone is 1/12. It may seem that twelve-tone music does not have a K spectrum, which would defy the claim that all musical sets have a K spectrum. But if it were true that all twelve-tone sequences have equal intellectual value, then it would not be possible for twelve-tone music to have achieved cultural significance. The chromatic sequence, for instance, is not surprising but some twelve-tone sequences (the one-family subsets of the twelve-tone product set) are more pleasing. Without a musical key center, the twelve-tone set is not totally-ordered, so the scale has no K spectrum, but the scale product set does have a K spectrum and weighted paths of tone movement.

Homotopic harmonic theory, which is the theory that all loops in music have a system fundamental in common, is understood using music graphology. If there are more than two loops, a torus manifold is excluded and only a spherical manifold is possible. Euler's tone net is closed but is not a semi-algebraic set closed to projection.

Having conceived of the tone net in the R² coordinate plane, Euler constructed a higher-dimensional Euclidean space of pitch values, as if a harmonic system could have an infinite number of fundamentals. But no one has ever found a use for higher-order pitch value space. A pitch value space seems like a natural extension of music topology but it's all nonsense. Pitch value space has no K spectrum 50 since the use of higher dimension of pitch, unlike certain special tuples, have not been popular. The expansive symmetry of Euler's pitch value space seems to imply that every subset of Rⁿ is as good as every other subset. Pitch value space is trivial, but pitch-position space is topologically non-trivial.

### Proof VI: Inductive Triangulation and Vector Equation Examples

While orthonormal vector equations demonstrate tablature computability, the equations do not necessarily, absolutely and conclusively prove there is not some unknown equation that cannot be computed. But it is possible to show there can only be a single matrix formula in the left adjoint free functor.

Observe the following useful vanishing polynomials in the guitar model algebraic closure operator 1) Pitch=Tuning+Intonation; 2) Pitch Value Vector=Fret Value Vector+Summation Vector; 3) Tuning-Key Change Vector=Tuning Change Vector+Key Change Vector; 4) Fret Index Number (String 1)+F₁=Fret Index Number (String 2); 5) Number of impossible intervals on String 1=(F₁)²; 6) OLMKT=MKT+G.

Equations 1-6 in the above paragraph can be treated as simple ABC triangle sums, but they are also algebraic products. Simplistically the pitch exponents add and the frequencies multiply. Mathematically sum and product are the same because the octave identity contains both 0 and 1.

Also, note that the typical form of the ABC equation in Tablature construction is composition (a+b=c) and decomposition (a=b+c), while the vanishing or cipher form of triangle ABC as a+b+c=0 is the important topologic equation in the form of the diaphanous Hilbert polynomial f(x)=0.

A practical example: The vector equation for changing guitar tuning and key may seem tautological: Tuning-Key Changing Vector=Tuning Changing Vector+Key Change Vector. (T−K=T(G)+K).

(2 0 0 0 0 0) is a transformation vector or tone movement vector that changes the tuning, but does not the key because only one string is altered while a key change must affect each string equally. On the other hand, the vector (−2 −2 −2 −2 −2 −2) changes key and does not change tuning because every string intonation changes by an equal pitch value increment, which raises the intonation of the system as a whole.

Combining the two vectors above in a product/sum vector (0 −2−2−2−2−2) changes both the key and the tuning in one operation. The K spectrum of these vectors for the morphism that changes Standard Tuning to Drop D shows that the last vector is most probable usage.

The practical significance of this vector to the guitarist is that the vector changes the tuning-key pairs in the best way possible, by changing the Key of E Standard Tuning to the Key of D Drop-D Tuning. This inaudible path of tone movement is a favored transition of state since D is the favored key in Drop D. E is less favored, and E-flat is the most improbable key. (1 −1 −1 −1 −1 −1) works as a tuning change but no one would want to use it, judging both by the observed K spectrum and also judging by the geometric logic against the probability of using the Key of E-flat in Drop D Tuning.

All vectors in music have an inner product of zero. The cross-product of the two vectors for changing tuning and tuning-key in the above example is zero [(2 0 0 0 0 0)×(0 −2 −2 −2 −2 −2)=(0 0 0 0 0 0)].

Key of E is favored in Standard, but Key of D has greater utility in Drop-D. Therefore Key of D and Key of E do not have the same probability of use, and therefore one key is more useful and more generally correct than the other key. The keys are not equal and the method of changing keys and tunings are also not equally-probably. Holding the guitar key constant at E when changing from Standard to Drop-D is a less useful path to follow, which shows how the T(G) uses a K probability function of the tuning called the most-favored key function probability, not pitch intelligence, to decide how to change tunings in the best way.

Our invention triangulates points and lines in mathematic product sets fields and uses a novel, original, and useful system of naming the coordinates of ABC triangles, triangles mathematicians call monads. The collection of monads described in tautologic repetition in this application make a new theory of all music theories. Mathematicians call a theory of theories a topos. The topos of music is the ABC monad connected to images of the monad tuple in Rⁿ observed in the R² coordinate plane by the arrows of the geometric projection apparatus.

Our apparatus that constructs and proofs Tablature music will cause people to view Tablature as a literate idiom and to save time, money, and effort learning guitar using a natural system of representing guitar music as simple sums and triangles.

Our invention demonstrates the left adjoint free functor can pull back guitar intelligence using a matrix formula. The K spectrum intelligence is a proof because the K spectrum confirms the existence of inductive predicate logic in integral domains that are the atomic element in the quantum music theory of atomic state of system transitions and their spectral image graphs.

The Turing machine of Guitar G constructs and proofs Tablature sentences for guitar but does not actually write music like an author writes a story. That text with the music pitch intelligence story is the machine input data which is used to make an initial and illiterate guess construction of an L-sentence. Then, in a second step, the initial guess is rectified with the truth structure and by that proofed as correct before outputting the data of truth structure-proofed Tabs. Constructing and proofing Tabs is using a truth structure book that requires T(G) as a guitar enigma machine to crack the secret guitar code signature similar to a foreign language translation.

Our object is to represent guitar intonation fields (transitions in system state) in a natural way using triangles. The object that ties together the repetitive examples are the trivialization, triangulation, and connectedness of musical spaces, and the minimal intelligence required to learn something like guitar.

The guitar model can be usefully represented in graphs and diagrams, and also in matrices, lattices, partial orders, paths, trees, Booleans, products, and so on. The value of the guitar intelligence model is that it can be re-stated in endlessly different ways that serve different points-of-view. The problem is that guitar intelligence is difficult to understand intuitively without a topologic model.

For partial orders, the Hasse Diagram Theorem tells that partially ordered sets, like logic circuits and Tabs that are represented by product sets of [0, 1] are not intuitive spaces to imagine or visualize, but nonetheless the product set of the octave identity can always be drawn as a useful diagram even if not a completely accurate drawing. (See FIG. 3E representing a Hasse Diagram.)

Examples of partial orders in music theory language signatures that can be diagramed as a graph include: 1) the musical key tonal center; 2) the range of the guitar; 3) the range of a string; 4) the guitar lattice; 5) tablature field; 6) the spectrums of guitar and the spaces; and other integral domains that are defined by partial orders. The partial orders make the integral domain structures in music constructable unit subsets of the more maximal musical topology in general.

However, every integral domain is not equal in utility value; some integral domains work well, but most do not. Knowing which integral domains to study saves money, time, and effort learning music.

The octave defines the identity of a Least Upper Boundary (LUB) of the integral domain as the highest note and the Greatest Lower Boundary (GLB) is the lowest. Partial orders, which are represented by a less-than symbol (s), are structures easily extended to trees, paths, lattices, monads, frames and all kinds of topologic constructions.

The partial order captures the idea of equivalence (if A≦B, and B≦A, then A=B). The Guitar Baire Category Theorem captures precisely the guitar model. If the guitar strings are closed (less than G, a constant) and also open (greater than G, a constant), then it must be true that T(Guitar Strings) is equal to T(G). The Baire Proof is an absolutely pre-emptive proof, and surprisingly complete, coherent, continuous, compact, decidable, predictive, sound, analytic, discrete, and simple.

The Hasse diagram is useful as a first step diagram in music. The next topologic step is the Stone Representation Theorem, which tells us that guitar circuitry has a useful geometric diagram and a natural equational representation.

Finally, at the highest level, the Stone-Cech Compactification Theorem proves that if the guitar model is compact, then the guitar model includes a left adjoint free functor matrix formula in the algebraic closure. Evidence is disclosed herein to show the guitar in first-order model theory is a Turing machine.

Spectrology and graphing are complementary tools for music intelligence and education.

The Baire Turing machine proof proves that tonality is the algebraic closure (intersection) of the subsets of the product set of the musical key—not the musical key itself, as is commonly taught. The fact that each element in music topology has its own spectral image observable as a K spectrum graph in the R² coordinate plane means the spectral theory of music is useful in many applications.

The mathematic language of quantifier elimination is important because it discloses the mathematic nature of motivation in natural representation and simple diagrams that result when points and intervals are defined in the real closed field.

Without a guitar tuning theory, previously no one had reason to: 1) predict that music has a spectrum, 2) to notice that the bipartite music graph has a utility graph problem, 3) to check to see if music has S03 symmetry 4) to define logic and probability in music.

The Baire Proof of Existence leads to a new way of understanding music and looking at music in graphs and diagrams.

“L is proof of G” is a simple, uncontestable proof that guitar tuning is a five-tuple with a field of zeros. This tuple observation immediately leads to the revelation: If it is true that the guitar tuning tonality is the closure of a five-tuple, then, because whatever is true for guitar is also true for music, the five-tuple proof suggests that tonality in music in general is the family of subset of the musical key product set topology.

The use of T(G) is for changing the guitar tuning and guitar key. This makes T(G) a guitar intelligence search engine. The operator, by going back and forth between different tunings, keys, and scores, begins with a guess and converges on guitar music literacy proof-by-proof, until every possible proof is mastered. T(G) is used to construct and proof a guitar music library.

Guitar music is expressive and original but as the rules for playing guitar become more complex, learning guitar in a reasonable period of time becomes difficult. Learning one tuning signature may take years. Therefore any system that makes learning guitar easier is important. A system that makes guitar music intelligible by connecting extremely disconnected forms of intelligence is a sublime apparatus for those who want to learn to play guitar.

The K spectrum 50 is proof that there are guitar tunings that are “golden tunings” of substantial intellectual value for learning guitar, and for these, the probability of use is high, but mastery is still difficult. Also, the ways of changing guitar tuning and key are not equal, and these morphisms also have a K spectrum 50. Why waste time changing guitar tunings in a way that is not K-spectrum correct? Once the correct way of changing tuning is proofed, it does not have to be proofed again.

The “paint-by-numbers” utility of Tablature music allows a Tablature user to learn to play guitar without learning to read music first. The problem is that Tablature is a data strip of numbers that have no meaning outside the guitar tuning. The fact that our Tablature-proofing Apparatus does not require learning music first, compliments and supplements the fact that Tablature can be read without learning to read music.

Our Turing machine, in contrast to the trial-and-error method of learning guitar, is initialized to an arbitrary tuning and then correctly writes the guitar music output in the mathematically best possible Tabs by reasoning according to the guitar tuning's finite list of programmable and computable instructions that initialized the Tablature computer.

Pitch transcription machines for learning guitar, however accurate, are pushdown automatons that do not output guitar intelligence, but our Turing machine uses a perspective guitar projection that is internal to the guitar tuning space to relax the 1-to-1 pitch-position equivalence.

Pitch values are limiting values, which are the same for all guitar tunings and keys, and will always proof correct for pitch.

Guitar music gibberish is a technical term of art defined herein as tablature badly written for guitar using observed pitch values (musical key) but the wrong guitar tuning, guitar key, and guitar position values. Gibberish is a peculiar partial-sense, partial-nonsense error (correct pitch, incorrect guitar position). Gibberish sounds correct on guitar played slowly, but is often too difficult to play at correct tempo. Gibberish wastes time, effort, and money and causes musicians to learn guitar the wrong way and further confuses proper use of Tablature to learn guitar correctly.

Guitar music gibberish causes Tablature to be commonly considered as something less than a valid literature, but because most guitarists do not read or write music, and publishers have no way to prevent gibberish errors in their guitar music publications. In fact, many guitarists do not even think it is possible to accurately write guitar music.

Our invention T(G) rectifies gibberish while the Tablature that is constructed as a proof of G is the output data, the best possible Tab having both right pitch and right position. The tree used as a path by the Tablature machine is superior to trial-and-error methods for learning.

The phase “open set of the musical key that does not contain the musical key itself” is critical to case that guitar tuning is original to music. The guitar key does not depend on the observed musical key in any way. More specifically, the guitar tuning does not contain the musical key itself, but instead the guitar tuning contains a unique set of musical keys whose expression must be completely relearned.

The guitar key is a different tonality than the musical key. Some musical key elements are redundant and other chords, interval, scales are not included, or are not useful. The result is a special tonality which appears inexplicable without knowing the language. The Key of C in Open G is not the Key of C on piano. Some chords and scales are not included on guitar at all, or are included in forms that do not have a reasonable probability of use in the K spectrum order, while other elements are present in redundant forms that are favored by probability of use.

A profound illusion is created by the guitar, since every guitar key seems the same as the musical key on intonation, and the secret is only penetrated by seeing, touching, and reasoning algebraically internal to the guitar.

Guitar music intelligence cannot be understood by mere auditory surveillance; learning guitar requires seeing and touching the guitar and most of all learning guitar requires the system of inductive reasoning which is the only possible way to discover the truth structure of the guitar tuning signature.

For instance, when music on guitar commutes to work at a new location in a new tuning, the meaning of true and false in tablature sentence does not depend in any way on what may be true in the old tuning because only the signature of the tuning used to write the Tab output and which is used to initialize the Turing machine determines whether or not the Tablature in print is drawn correctly in the field of the tuning space.

It may not seem surprising that our T(G) invention is a machine that writes music like a human given the machine described here is operated by a human. The point of apparatus for learning guitar is that the T(G) operator starts in a completely illiterate state and learns guitar, becoming literate directly from the guitar tuning and nothing else. That is a unique property of L-languages, that they can be learned from the language signature.

Tablature, or scordatura (meaning the bad score, usually in reference to violin tabs) often seems to be an idiosyncrasy rather idiomatic because there is no meaningful geometric interpretation of the Tablature Algebraic Closed Field. No one knows whether or not tablature is correctly proofed or not without learning the inductive language first.

An Ada Lovelace quote in Science magazine (11 Dec. 2015, Volume 350, page 1323) regarding Babbage's Analytical Engine, could equally apply to the tablature proofing engine:
“The engine can arrange and combine its numerical quantities exactly as if they were letters or any other general symbols; and in fact it might bring out its results in algebraic notation . . . . Supposing, for instance, that the fundamental relations of pitch sound in the science of harmony and music were susceptible of such expression and adaptations, the engine might compose elaborate pieces and scientific pieces of any degree of complexity or extend.”

We claim:

1. A method for transforming written music from a first state for playing on a first musical instrument into a second state for playing on a guitar comprising:
providing a first visually perceptible musical score in a first tuning in a first key for playing on a first musical instrument by a human;
providing an algorithm implemented by a machine; and
inputting the first visually perceptible music score into the machine which generates as an output a second visually perceptible musical score in a second tuning in a second key for playing on a guitar by a human.

2. The method for transforming written music of claim 1 and wherein:
the algorithm first defines an S spectrum of prime ideals elements of the first tuning;
the algorithm second defines a Z spectrum which is a summation of the S spectrum of prime ideals elements present in a musical key product set of the first tuning; and
the algorithm third, for any set of intonation values, defines a K probability spectrum by counting the usage of each element in each musical key product set.

3. The method for transforming written music of claim 1 and wherein:
the algorithm uses K-Spectrum facts collected from the K spectrums to construct a library of L sentences in a log space family of L languages, and the L sentences are proofed in L tablature notation using K spectrum intelligence.

4. The method for transforming written music of claim 1 and wherein:
the algorithm uses K-Spectrum facts to proof L-Sentences according to an identified guitar signature.

5. A tablature proofing turning machine for transforming written music from a first state for playing on a first instrument into a second state for playing on a guitar comprising:
an algorithm implemented by a machine that always halts on the best harmonic set element, and self-learns beginning from an illiterate state and thereafter learning how to play, write, read, edit, and proof guitar music to the point of intonation at a specific pitch.

6. The turning machine of claim 5 wherein:
the touring machine overcomes the problem of losing the musical key and tuning by affine projection using a language level structure of knowledge.

7. The turning machine of claim 5 wherein:
the machine makes guitar music more authentic, reproducible, and reliable.

8. The turning machine of claim 5 wherein:
the machine saves time, money and reduces effort required to learn to play guitar.

9. The turning machine of claim 5 wherein:
the machine permits transformation of piano music literature into guitar music literature with accuracy and a high intellectual standard.
